(19) United States
(12) Patent Application Publication
(10) Pub. No.: US 2015/0339589 A1
(43) Pub. Date: Nov. 26, 2015

(54) APPARATUS AND METHODS FOR TRAINING ROBOTS UTILIZING GAZE-BASED SALIENCY MAPS

(71) Applicant: BRAIN CORPORATION, San Diego, CA (US)

(72) Inventor: Dimitry Fisher, San Diego, CA (US)

(73) Assignee: BRAIN CORPORATION, San Diego, CA (US)

(21) Appl. No.: 14/284,120

(22) Filed: May 21, 2014

(51) Int. Cl. G06N 99/00; B25J 9/16

(52) U.S. Cl. CPC G06N 99/005; B25J 9/16

(57) ABSTRACT

Robotic devices may be trained using saliency maps derived from gaze of a trainer. In navigation applications, the saliency map may correspond to portions of the environment being observed by a driving instructor during training using a gaze detector. During an operation, a driver assist robot may utilize the saliency map in order to assess attention of the driver, detect potential hazards, and issue alerts. Responsive to a detection of a mismatch between the driver current attention and the target attention derived from the saliency map, the robot may issue a warning, and/or prompt the driver of an upcoming hazard. A data processing apparatus may employ gaze based saliency maps in order to analyze, e.g., surveillance camera feeds for intruders, open doors, hazards, policy violations (e.g., open doors).

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

1. Technological Field

The present disclosure relates to machine learning, operation, and training of robotic devices.

2. Background

Robotic devices may be used in a variety of applications, such as manufacturing, medical, safety, military, exploration, elder care, healthcare, and/or other applications. Some existing robotic devices (e.g., manufacturing assembly and/or packaging robots) may be programmed in order to perform various desired functions. Some robotic devices (e.g., surgical robots) may be remotely controlled by humans. Some robotic devices may learn to operate via exploration.

Programming robots may be costly and remote control by a human operator may cause delays and/or require high level of dexterity from the operator. Furthermore, changes in the robot model and/or environment may require changes in the programming code. Remote control typically relies on user experience and/or agility that may be inadequate when dynamics of the control system and/or environment (e.g., an unexpected obstacle appears in path of a remotely controlled vehicle) change rapidly.

### SUMMARY

One aspect of the disclosure relates to a system configured for determining a saliency map. The system may comprise a first sensing apparatus, a second sensing apparatus, and one or more processors. The first sensing apparatus may be configured to provide sensory input associated with a task being executed by a robotic device operable by a trainer. The second sensing apparatus may be configured to provide information related to a gaze parameter associated with a present gaze of the trainer. The one or more processors may be communicatively coupled with one or both of the first sensing apparatus or the second sensing apparatus. The one or more processors may be configured to execute computer program instructions to cause the one or more processors to: determine one or more features within the sensory input using an adaptive process; determine a salient area within the sensory input based on the gaze parameter; associate the salient area with at least one of the one or more features; and update a learning parameter of the process based on an evaluation of the association. The learning process may be characterized by a performance measure. The update may be configured to effectuate autonomous execution of the task by the robotic device in an absence of the trainer. The saliency map may comprise the salient area.

In some implementations, the present gaze may be configured to convey information related to direction of eye sight of the trainer. The sensory input may comprise a first image and a second image both conveying information related to an environment surrounding the robotic device during execution of the task. The gaze parameter may be determined based on an operation configured using to a first portion within the first image and a second portion of the second image being gazed at by the trainer.

In some implementations, the operation may comprise a weighted average of the first portion and the second portion.

In some implementations, the sensory input may comprise an image characterized by a spatial extent. The image may convey information related to an environment surrounding the robotic device during execution of the task. The present gaze of the trainer may be characterized by a plurality of areas within the spatial extent being observed by the trainer. A given area within the spatial extent may be characterized by a duration of the present gaze directed to the given area, a location of the given area within the spatial extent, and a perimeter of the given area. The gaze parameter may be determined based on a spatial average of the individual areas.

In some implementations, the sensory input may comprise another image conveying information related to the environment surrounding the robotic device during execution of the task. The gaze parameter may be determined based on a temporal average of the individual areas associated with the image and the other image.

In some implementations, the association of the salient area with the at least one of the one or more features may comprise determining a first location within the image associated with the salient area and a second location within the image associated with the at least one of the one or more features. The evaluation may comprise a determination of a similarity measure between the first location and the second location.

In some implementations, the one or more processors may be configured to operate a network of a plurality of computerized neurons configured to implement the learning process. The network may comprise an input layer of neurons and an output layer of neurons.

In some implementations, the similarity measure may be configured to provide a discrepancy between the first location and the second location. The update may be configured based on propagation of the discrepancy from the output layer back to the input layer.

In some implementations, the system may comprise a nonvolatile storage medium configured to store the updated learning parameter. The second sensing apparatus may comprise an optical gaze tracker comprising a transmitter element configured to illuminate an eye of the trainer. The second sensing apparatus may comprise a receiver element configured to detect a waveform reflected by the eye.

Another aspect of the disclosure relates to a non-transient computer-readable storage medium having instructions embodied thereon. The instructions may be executable to cause one or more processors to: determine of a gaze of a person executing a task; determine one or more features in sensory input associated with the task; select a salient feature from the one or more features, the selection being based on an operation of a predictor process characterized by a parameter; associate an area of the gaze of the person with a portion of the sensory input; and provide an indication to the person. The indication may convey information associated with the salient feature and the area. The parameter may be based on an evaluation of gaze of another person during a prior execution of the task prior.

In some implementations, the indication may comprise an alert for the person. The alert may be responsive to a discrepancy between (i) an area of the sensory input associated with the salient feature and (ii) the area of the gaze. The alarm may be configured to attract attention of the person to the discrepancy.

In some implementations, the alarm may comprise one or more of an audible indication, a visible indication, or tactile indication.

In some implementations, the task may comprise navigating a trajectory by a vehicle. The alarm may be configured to indicate to the person the area of the sensory input associated with the salient feature. The alarm may be configured to cause generation of a graphical user interface element on a display component of the vehicle. The display component may be configured to present to the person at least a portion of the sensory input.

In some implementations, the silent feature may comprise an object disposed proximate the trajectory. The graphical user interface element may convey one or more of a location of the object or a boundary of the object.

In some implementations, the salient feature may be determined based on determining a salient area within the sensory input. The indication may comprise an alert for the person. The alert may be responsive to an absence of the gaze within the salient area for a period of time.

In some implementations, the task may comprise navigating a trajectory by a vehicle. The sensory input may comprise a sequence of frames obtained at an inter frame duration. The interval may comprise a period of multiple inter-frame durations.

In some implementations, for an inter frame duration of 40 milliseconds, the interval may be selected to be greater than 400 milliseconds.

Yet another aspect of the disclosure relates to a method for operating a robotic apparatus to perform a task. The method may comprise: for a given visual scene: determining a feature within a portion of a digital image of the visual scene, the determination being based on an analysis of a saliency map associated with the task, the saliency map being representative of one or more areas of preferential attention by a human trainer; and executing the task based on an association between with the feature and the task. The saliency map may be determined by a learning process of the robotic apparatus. The association between with the feature and the task may be determined by the learning process. The learning process may have been previously trained to execute the task using gaze of the human trainer.

In some implementations, the method may comprise using the saliency map, as determined from the human gaze, to specify the feature associated with the robotic apparatus so that the robotic apparatus learns the association between the feature and the task.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and in the claims, the singular form of “a”, “an”, and “the” include plural referents unless the context clearly dictates otherwise.

### BRIEF DESCRIPTION OF THE DRAWINGS

FIG. 1 is a graphical illustration depicting a robotic apparatus useful for operation with gaze based saliency maps, in accordance with one or more implementations.

FIG. 2 is a graphical illustration depicting use of gaze-based saliency map when operating a robotic vehicle, e.g., of FIG. 1, in accordance with one or more implementations.

FIG. 3 is a graphical illustration depicting use of an adaptive gaze based saliency maps apparatus in a surveillance application, in accordance with one or more implementations.

FIG. 4 is a graphical illustration depicting a sensory frame usable for training an adaptive controller to determine a saliency map using gaze information, in accordance with one or more implementations.

FIG. 5A is a functional block diagram illustrating an adaptive controller configured to learn saliency determination in a sensory input based on a gaze of a trainer, in accordance with one or more implementations.

FIG. 5B is a functional block diagram illustrating operation of an adaptive controller configured to determine an output configured based on a salient feature determination and/or user gaze, in accordance with one or more implementations.

FIG. 5C is a functional block diagram illustrating operation of an adaptive controller operable to determine a salient feature, in accordance with one or more implementations.

FIG. 6A is a plot illustrating saliency determination using a Gaussian spatial kernel, in accordance with one or more implementations.

FIG. 6B is a plot illustrating saliency determination using a time history of gaze information, in accordance with one or more implementations.

FIG. 7 is a plot illustrating saliency determination using a spatial gaze distribution with iterative offline learning, in accordance with one or more implementations.

FIG. 8 is a logical flow diagram illustrating a method of determining a saliency map based on gaze of a trainer, in accordance with one or more implementations.

FIG. 9A is a logical flow diagram illustrating a method of operating a robotic device using gaze based saliency maps, in accordance with one or more implementations.

FIG. 9B is a logical flow diagram illustrating a method of using a saliency map by a computerized device to provide an attention indication to a, in accordance with one or more implementations.

FIG. 9C is a logical flow diagram illustrating a method of processing sensory information by a computerized device using saliency maps, in accordance with one or more implementations.

FIG. 10 is a functional block diagram illustrating components a robotic controller apparatus for use with the trainable convolutional network methodology, in accordance with one or more implementations.

All Figures disclosed herein are © Copyright 2014 Brain Corporation. All rights reserved.

### DETAILED DESCRIPTION

Implementations of the present technology will now be described in detail with reference to the drawings, which are provided as illustrative examples so as to enable those skilled in the art to practice the technology. Notably, the figures and examples below are not meant to limit the scope of the present disclosure to a single implementation, and other implementations are possible by way of interchange of or combination with some or all of the described or illustrated elements. Wherever convenient, the same reference numbers will be used throughout the drawings to refer to same or like parts.

Where certain elements of exemplary implementations may be partially or fully implemented using known components, only those portions of such known components that are necessary for an understanding of the present disclosure will be described, and detailed descriptions of other portions of such known components will be omitted so as not to obscure the disclosure.

In the present specification, an implementation showing a singular component should not be considered limiting; rather, the disclosure is intended to encompass other implementations including a plurality of the same component, and vice-versa, unless explicitly stated otherwise herein.

Further, the present disclosure encompasses present and future known equivalents to the components referred to herein by way of illustration.

As used herein, the term “bus” is meant generally to denote all types of interconnection or communication architecture that is used to access the synaptic and neuron memory. The “bus” may be electrical, optical, wireless, infrared, and/or another type of communication medium. The exact topology of the bus could be for example standard “bus”, hierarchical bus, network-on-chip, address-event-representation (AER) connection, and/or other type of communication topology used for accessing, e.g., different memories in pulse-based system.

As used herein, the terms “computer”, “computing device”, and “computerized device” may include one or more of personal computers (PCs) and/or minicomputers (e.g., desktop, laptop, and/or other PCs), mainframe computers, workstations, servers, personal digital assistants (PDAs), handheld computers, embedded computers, programmable logic devices, personal communicators, tablet computers, portable navigation aids, J2ME equipped devices, cellular telephones, smart phones, personal integrated communication and/or entertainment devices, and/or any other device capable of executing a set of instructions and processing an incoming data signal.

As used herein, the term “computer program” or “software” may include any sequence of human and/or machine cognizable steps which perform a function. Such program may be rendered in a programming language and/or environment including one or more of C/C++, C#, Fortran, COBOL, MATLAB®, PASCAL, Python®, assembly language, markup languages (e.g., HTML, SGML, XML, VoXML), object-oriented environments (e.g., Common Object Request Broker Architecture (CORBA)), Java® (e.g., J2ME®, Java Beans), Binary Runtime Environment (e.g., BREW), and/or other programming languages and/or environments.

As used herein, the terms “connection”, “link”, “transmission channel”, “delay line”, “wireless” may include a causal link between any two or more entities (whether physical or logical/virtual), which may enable information exchange between the entities.

As used herein the term gaze is used to refer to a direction of eye sight of a human. The eye sight direction may comprise, for example, direction of the center of a pupil or direction that projects onto the center of the fovea of the eye retina of the human.

As used herein, the term “memory” may include an integrated circuit and/or other storage device adapted for storing digital data. By way of non-limiting example, memory may include one or more of ROM, PROM, EEPROM, DRAM, Mobile DRAM, SDRAM, DDR/2 SDRAM, EDO/FPMS, RLDRAM, SRAM, “flash” memory (e.g., NAND/NOR), memristor memory, PSRAM, and/or other types of memory.

As used herein, the terms “integrated circuit”, “chip”, and “IC” are meant to refer to an electronic circuit manufactured by the patterned diffusion of elements in or on to the surface of a thin substrate. By way of non-limiting example, integrated circuits may include field programmable gate arrays (e.g., FPGAs), a programmable logic device (PLD), reconfigurable computer fabrics (RCFs), application-specific integrated circuits (ASICs), printed circuits, organic circuits, and/or other types of computational circuits.

As used herein, the terms “microprocessor” and “digital processor” are meant generally to include digital processing devices. By way of non-limiting example, digital processing devices may include one or more of digital signal processors (DSPs), reduced instruction set computers (RISC), general-purpose (CISC) processors, microprocessors, gate arrays (e.g., field programmable gate arrays (FPGAs)), PLDs, reconfigurable computer fabrics (RCFs), array processors, secure microprocessors, application-specific integrated circuits (ASICs), and/or other digital processing devices. Such digital processors may be contained on a single unitary IC die, or distributed across multiple components.

As used herein, the term “network interface” refers to any signal, data, and/or software interface with a component, network, and/or process. By way of non-limiting example, a network interface may include one or more of FireWire (e.g., FW400, FW800, and/or other FireWire implementation), USB (e.g., USB2), Ethernet (e.g., 10/100, 10/100/1000 (Gigabit Ethernet), 10-Gig-E, and/or other Ethernet variant), MoCA, Coaxsys (e.g., TVnet™), radio frequency tuner (e.g., in-band/or OOB, cable modem, and/or other RF variant), Wi-Fi (802.11), WiMAX (802.16), PAN (e.g., 802.15), cellular (e.g., 3G, LTE/LTE-A/TD-LTE, GSM, and/or other cellular standard), IrDA families, and/or other network interfaces.

As used herein, the terms “node”, “neuron”, and “neuronal node” are meant to refer, without limitation, to a network unit (e.g., a spiking neuron and a set of synapses configured to provide input signals to the neuron) having parameters that are subject to adaptation in accordance with a model.

As used herein, the terms “state” and “node state” is meant generally to denote a full (or partial) set of dynamic variables used to describe node state.

As used herein, the term “synaptic channel”, “connection”, “link”, “transmission channel”, “delay line”, and “communications channel” include a link between any two or more entities (whether physical (wired or wireless), or logical/virtual) which enables information exchange between the entities, and may be characterized by a one or more variables affecting the information exchange.

As used herein, the term “Wi-Fi” includes one or more of IEEE-Std. 802.11, variants of IEEE-Std. 802.11, standards related to IEEE-Std. 802.11 (e.g., 802.11 a/b/g/n/s/v), and/or other wireless standards.

As used herein, the term “wireless” means any wireless signal, data, communication, and/or other wireless interface. By way of non-limiting example, a wireless interface may include one or more of Wi-Fi, Bluetooth, 3G (3GPP/3GPP2), HSDPA/HSUPA, TDMA, CDMA (e.g., IS-95A, WCDMA, and/or other CDMA variant), FHSS, DSSS, GSM, PAN/802.15, WiMAX (802.16), 802.20, narrowband/FDMA, OFDM, PCS/DCS, LTE/LTE-A/TD-LTE, analog cellular, CDPD, satellite systems, millimeter wave or microwave systems, acoustic, infrared (i.e., IrDA), and/or other wireless interfaces.

Apparatus and methods for training of robotic devices utilizing gaze-based saliency maps are disclosed herein. Gaze-based maps may be used to refer to a spatial distribution of locations in images of the surroundings that correspond to direction of eye sight of a human performing a task within the surroundings. The eye sight direction may comprise direction of the center of a pupil or direction that projects onto the center of the fovea of the eye retina of the human.

Robotic devices may be trained to perform a target task (e.g., recognize an object, navigate a route, approach a target, avoid an obstacle, and/or other tasks). In some implementations, performing the task may be achieved by the robot by following one of two or more spatial trajectories. During trajectory navigation, controller of the robot may obtain context information related to environment of the robot (e.g., presence and/or location of objects). The controller operation may be aided by gaze-based saliency maps configured to aid the controller to determine the importance of features or objects in a sensory scene, and/or to direct its attention appropriately.

In one or more of its implementations, saliency maps may be determined by (1) mapping the relative importance of features and objects in the visual scene by means of gaze tracking, (2) converting the gaze map into an saliency map, and (3) training the controller (e.g., a robot, an AI agent, and/or a computer algorithm) to predict the saliency map for a particular task and/or a set of tasks.

It will be appreciated by those skilled in the arts that saliency maps may comprise dynamic maps modified in accordance with the sensory input. In some implementations, the saliency map may be determined based on the user's gaze. In one or more implementations, the saliency map may be determined by an exemplary apparatus that was previously trained to predict the saliency map using the human gaze as a training signal. The saliency map may be evaluated on a frame-by-frame scale. The saliency map determination may be performed synchronously with the acquisition of video frames and/or at a small processing delay. In some implementations, the saliency maps may be updated at specified intervals (e.g., ten updates per second).

It will be appreciated by those skilled in the arts that the saliency map prediction may not be restricted to the use of a given frame of the sensory input (e.g. the most recent frame) as the sole source of saliency information. Additional data may be used to provide context for saliency determination. In some implementations, history and/or continuity of sensory input may be used. By way of an illustration, a single image may not provide information related to relative motion of objects in the image. Using several consecutive images may enable estimation of the object motion. In one or more implementations of surface vehicle navigation. As another example, location (e.g., a region, country, and/or continent) may provide context useful for saliency determination as in the countries with right-hand traffic (e.g. US, China, and/or other countries), a context information about the intended right turn of the vehicle may increase the relative salience of other vehicles approaching from the left and/or of the pedestrians and cyclists approaching from the right.

Any existing commercial and/or custom-built gaze tracker apparatus may be utilized in order to obtain gaze direction pattern of a human trainer executing a task. The gaze pattern may be the task dependent and highly indicative the overt attention of the human performing the task. The gaze pattern (saccades, fixations, and/or smooth pursuit) may be converted into a dynamic heat-map of attention (also referred to as “importance map”). In one or more implementations the attention map may be obtained using live image in real time and/or recorded video. The attention map may be stored in conjunction with the sensory input and/or context characterizing the task and/or the sensory input corresponds to the task. Context may include one or more of past sensory inputs (as-acquired and/or processed e.g. by dimensionality reduction techniques); present and/or past commands and user inputs; labels; tags; locations; task details; degree of success on the task; degree of task completion; corrections; alerts; warnings; and/or other information associated with context. The stored sensory input and/or context and the corresponding attention map may be utilized in order to train a controller of a robot, an AI, machine-learning, and/or a computer algorithm in order to assign and determine the importance of features or objects in a sensory scene, and/or to direct the attention appropriately.

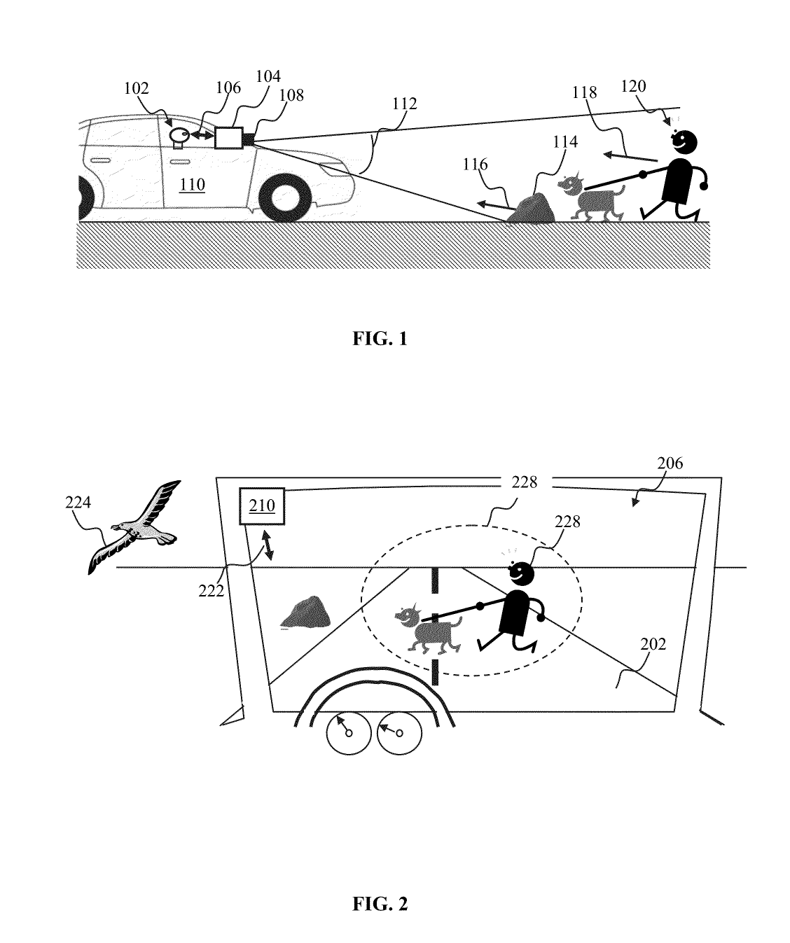

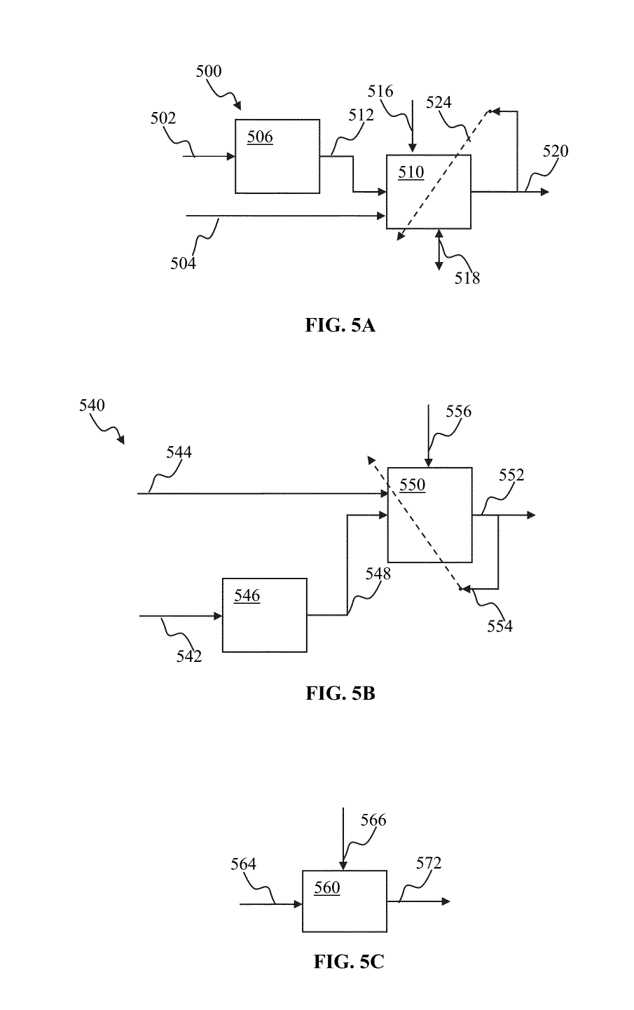

FIG. 1 depicts a vehicle 110 comprising an adaptive controller 104 configured for training and/or operation using gaze-based saliency maps methodology in accordance with one or more implementations. The vehicle 100 may be operable by a human trainer 102 and/or the controller 104. The controller 104 may comprise, e.g., the apparatus described with respect to FIG. 5A below. The controller 500 may perform a variety of operations including one or more of assisting the driver 102 during route navigation (e.g., by providing an alert related to an upcoming hazard), being used in training of drivers (novice and/or experienced), augment driver actions (e.g., the controller instructing the vehicle to execute a collision prevention action responsive to detection of an obstacle), alerting the driver responsive to detection loss of alertness (e.g., blind area), and/or other operations. In some implementations, the controller 500 may be embodied within an autonomously operated vehicle (not shown).

The controller 104 may comprise a sensor component 108. The sensor component 108 may be characterized by an aperture or field-of-view 112 (e.g., an extent of the observable world that may be captured by the sensor at a given moment). The sensor component 108 may provide information (e.g., 116, 118) associated with objects within the field-of-view 112, e.g., a rock 114 and/or a pedestrian 120. The information provided by the component 108 may be used to obtain context associated with task execution by the apparatus 110. In one or more implementations, the context may comprise one or more state parameters of the robotic apparatus, e.g., motion parameters, (vehicle lane, position, orientation, speed), robotic platform configuration (e.g., manipulator size and/or position), and/or available power. The context may further comprise one or more task parameters, e.g., route type (faster time, shorter route), route mission (e.g., surveillance, delivery), state of the environment (e.g., presence, location, size, and/or motion of one or more objects), environmental conditions (wind, rain), a time history of vehicle motions, and/or other characteristics.

In one or more implementations, such as object recognition, and/or obstacle avoidance, the output provided by the sensor component 108 may comprise a stream of pixel values associated with one or more digital images. In one or more implementations of e.g., video, radar, sonography, x-ray, magnetic resonance imaging, and/or other types of sensing, the sensor 108 output may be based on electromagnetic waves (e.g., visible light, infrared (IR), ultraviolet (UV), and/or other types of electromagnetic waves) entering an imaging sensor array. In some implementations, the imaging sensor array may comprise one or more of artificial retinal ganglion cells (RGCs), a charge coupled device (CCD), an active-pixel sensor (APS), and/or other sensors. The input signal may comprise a sequence of images and/or image frames. The sequence of images and/or image frame may be received from a CCD camera via a receiver apparatus and/or downloaded from a file. The image may comprise, for example, a two-dimensional matrix of red/green/blue (RGB) values refreshed at a 25 Hz frame rate. It will be appreciated by those skilled in the arts that the above image parameters are merely exemplary, and many other image representations (e.g., bitmap, CMYK, HSV, HSL, grayscale, and/or other representations) and/or frame rates are equally useful with the present disclosure. In some implementations, output of monochrome, depth, LIDAR. FLIR, other outputs, and/or combination thereof may be used with one or more methodologies described herein.

Pixels and/or groups of pixels associated with objects and/or features in the input frames may be encoded using, for example, latency encoding described in U.S. patent application Ser. No. 12/869,583, filed Aug. 26, 2010 and entitled “INVARIANT PULSE LATENCY CODING SYSTEMS AND METHODS”; U.S. Pat. No. 8,315,305, issued Nov. 20, 2012, entitled “SYSTEMS AND METHODS FOR INVARIANT PULSE LATENCY CODING”; U.S. patent application Ser. No. 13/152,084, filed Jun. 2, 2011, entitled “APPARATUS AND METHODS FOR PULSE-CODE INVARIANT OBJECT RECOGNITION”; and/or latency encoding comprising a temporal winner take all mechanism described U.S. patent application Ser. No. 13/757,607, filed Feb. 1, 2013 and entitled “TEMPORAL WINNER TAKES ALL SPIKING NEURON NETWORK SENSORY PROCESSING APPARATUS AND METHODS”, each of the foregoing being incorporated herein by reference in its entirety.

In one or more implementations, object recognition and/or classification may be implemented using spiking neuron classifier comprising conditionally independent subsets as described in co-owned U.S. patent application Ser. No. 13/756,372 filed Jan. 31, 2013, and entitled “SPIKING NEURON CLASSIFIER APPARATUS AND METHODS” and/or co-owned U.S. patent application Ser. No. 13/756,382 filed Jan. 31, 2013, and entitled “REDUCED LATENCY SPIKING NEURON CLASSIFIER APPARATUS AND METHODS”, each of the foregoing being incorporated herein by reference in its entirety.

In one or more implementations, encoding may comprise adaptive adjustment of neuron parameters, such neuron excitability described in U.S. patent application Ser. No. 13/623,820 entitled “APPARATUS AND METHODS FOR ENCODING OF SENSORY DATA USING ARTIFICIAL SPIKING NEURONS”, filed Sep. 20, 2012, the foregoing being incorporated herein by reference in its entirety.

In some implementations, analog inputs may be converted into spikes using, for example, kernel expansion techniques described in co-pending U.S. patent application Ser. No. 13/623,842 filed Sep. 20, 2012, and entitled “SPIKING NEURON NETWORK ADAPTIVE CONTROL APPARATUS AND METHODS”, the foregoing being incorporated herein by reference in its entirety. As used herein, the term analog input and/or analog signal is used to describe non-spiking signal (e.g., analog, continuous, n-ary digital signal characterized by n-bits of resolution, n>1). In one or more implementations, analog and/or spiking inputs may be processed by mixed signal spiking neurons, such as U.S. patent application Ser. No. 13/313,826 entitled “APPARATUS AND METHODS FOR IMPLEMENTING LEARNING FOR ANALOG AND SPIKING SIGNALS IN ARTIFICIAL NEURAL NETWORKS”, filed Dec. 7, 2011, and/or co-pending U.S. patent application Ser. No. 13/761,090 entitled “APPARATUS AND METHODS FOR IMPLEMENTING LEARNING FOR ANALOG AND SPIKING SIGNALS IN ARTIFICIAL NEURAL NETWORKS”, filed Feb. 6, 2013, each of the foregoing being incorporated herein by reference in its entirety.

In some implementations of robotic navigation in an arbitrary environment, the sensor component 108 may comprise a camera configured provide an output comprising a plurality of digital image frames refreshed at, e.g., 25 Hz frame rate.

The controller apparatus 104 may comprise an eye tracking component (also referred to as the gaze sensor) configured to determine gaze 106 of the human trainer 102. The gaze sensor may be configured to determine the motion of an eye relative to the outside world (e.g., the display screen, the road). Various methodologies may be employed in order to detect eye motion of the trainer, such as, e.g., non-contact, optical methods. In some implementations, a light emitter (e.g., infrared) may be utilized in order to illuminate (as shown by arrow 106) eye(s) of the trainer 102. The light reflected from the eye may be sensed by a camera and/or other optical sensor. The reflection information may be analyzed in order to extract eye rotation from changes in reflections. Video-based eye trackers may use the corneal reflection (the first Purkinje image) and the center of the pupil as features to track over time. In some implementations, the dual-Purkinje eye tracker may employ reflections from the front of the cornea (first Purkinje image) and the back of the lens (fourth Purkinje image) as features to track. Some implementations of eye tracking utilize image features from inside the eye, such as the retinal blood vessels, and follow these features as the eye rotates. In one or more implementations of gaze detection, eye pupil parameters may be determined, comprising for example, location and eccentricity of the pupil ellipsoid (4 parameters 2 per eye). In one or more implementations, pupil dilation may be evaluated when determining eye pupil parameters. A single eye or both eye data may be used in evaluating gaze. The pupil parameter may be referenced to an x-y image plane, associated with sensing array of the sensor 108.

During training, the eye tracking data (e.g., 106 in FIG. 1) and the sensory information (e.g., 116, 118 in FIG. 1) may be utilized in order to determine a saliency map, sensory context, and/or action between actions by the trainer and one or more salient objects determined on from the saliency map. By way of an illustration, an image frame provided by the sensor 108 may comprise representation 116 of a rock on a side of the road and a representation 118 of a pedestrian crossing the road. The trainer may focus attention (e.g., direct the gaze) at the representation 118 and apply brakes. Due to the trainer's gaze being predominantly located over the representation 118, the controller may determine a saliency map configured to assign a higher saliency score to the representation 118 compared to the representation 116. In some implementations the controller may operate a learning process configured to determine an association between the salient object (e.g., the representation 118) and the corresponding action (e.g., the application of the brakes).

The attention map may be stored in conjunction with the context characterizing the task (e.g., safely navigating the road trajectory) and/or the sensory input corresponding to the task (e.g., representations 116, 118). The stored context and the corresponding attention map may be utilized in order to train a controller of a robot, an AI, machine-learning, and/or a computer algorithm in order to assign and determine the importance of features or objects in a sensory scene, and/or to direct the attention appropriately. For example, consistent correlation between a pedestrian (the feature highlighted by the saliency map) and application of the brakes may enable the controller to learn to predict that the brakes should be applied whenever a pedestrian may appear in (and/or approaching) the path of the vehicle. The learning process itself may, for example, include extracting the ‘pedestrian’ sensory feature category from the input (camera, RADAR, LIDAR, and/or other sensor), and/or increasing the strength of the connection between the ‘pedestrian’ sensory feature and the ‘brakes’ motor action. It will be appreciated by the skilled in the arts that in absence of the saliency map such an association may be difficult or outright impossible to make, due to a large number of visual features and/or objects that may be present at any given time (birds, clouds, news kiosks, billboards, vegetation, buildings, and/or other features/objects). In a context of a particular task a subset of features may be relevant to execution of the task (e.g., the approaching pedestrian) that may be associated with braking Presence of other objects/features (e.g., a bird) may not be relevant to application of the brakes. The saliency map instructs the controller which one (or few) out of many features present should be associated with the action taken (braking)

During operation, the trained controller 104 may assist, e.g., a novice driver, to safely navigate trajectory using the as described in detail below with respect to FIG. 2.

FIG. 2 is a graphical illustration depicting use of gaze-based saliency map when operating a vehicle, in accordance with one or more implementations. Configuration shown in FIG. 2 may represent a view through the windshield (shown by arrow 206) of the vehicle (e.g., 110 shown and described with respect to FIG. 1 above). In one or more implementations, the windshield 206 may comprise a heads up display (HUD). The vehicle of FIG. 2 may be outfitted with a learning controller 204 that may be disposed proximate the windshield 206 and/or (not shown) on the vehicle dashboard. The controller 210 may comprise a sensor (e.g., the sensor 108 described above with respect to FIG. 1). The sensor may comprise a camera characterized by an aperture and configured to provide sensory information related to objects and/or obstacles. The sensory information may be configured to convey, for example, position of the vehicle on the road 202, presence of one or more objects proximate the road (e.g., 216, 224).

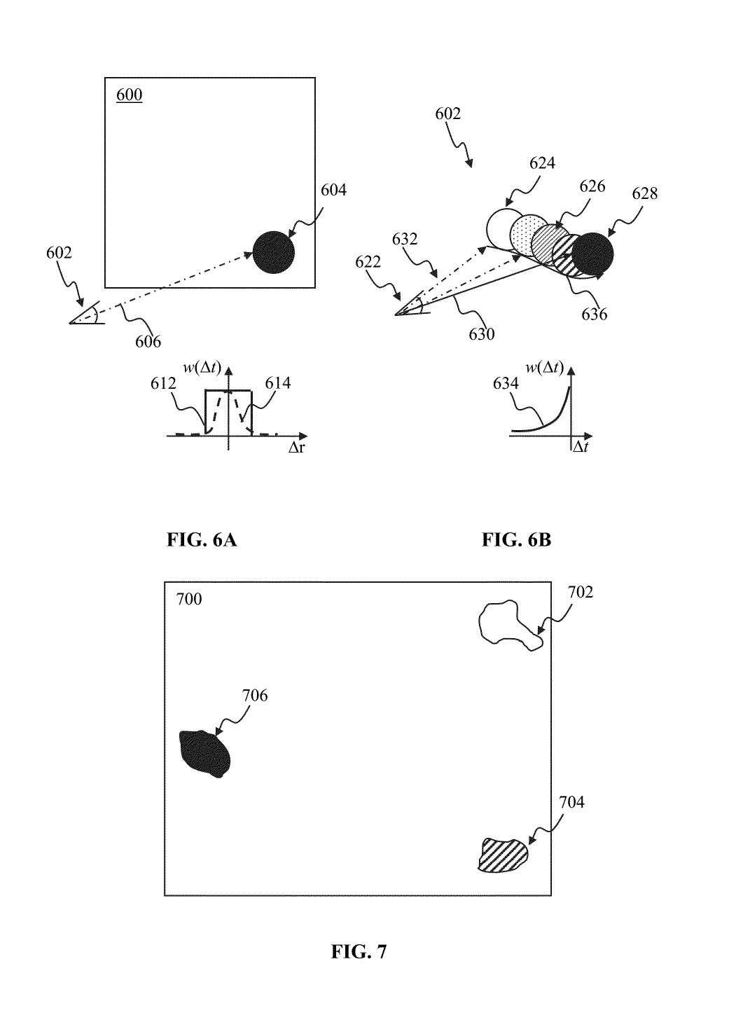

The controller 210 may comprise a gaze detection component configured to provide information related to current gaze 222 of the driver. In some implementations, the gaze detection component may comprise an optical gaze detector, e.g., as described above with respect to FIG. 1. Based on detection of a context, the controller 210 may access saliency map information obtained during training that may be associated with the context. For example, an experienced driver may train a controller to determine a saliency map for a task as described above. In one implementation, an experienced driver may operate, for a period of time, a vehicle equipped with the apparatus described herein. The saliency map (determined based on the experience driver's gaze) may be stored, in conjunction with the sensory input and/or the context information. The apparatus may be trained (on-line or off-line, on-the-fly or later on) to predict the saliency map, as produced by the experience driver's gaze, based on the sensory input and the context information. In some implementations, this saliency map may be used to train inexperienced drivers to allocate their attention and gaze appropriately. By way of an illustration, the context associated with sensory input of FIG. 2 may comprise representations of a rock 226, a pedestrian 228 crossing the road, vehicle speed, direction, lane position, and/or other parameter related to the task. The saliency map obtained during training and corresponding to the context of FIG. 2, may be configured to convey information indicating the most salient object (e.g., 228). The controller 210 may obtain present attention of the driver using the current gaze information 222 provided by the gaze determination component. When the novice driver may become distracted by one or more objects (e.g., the bird 224) the current gaze information 222 may indicate that the bird 224 comprises the salient object for the driver. The controller may detect a mismatch between previously learned saliency map (e.g. associated with the pedestrian 228) and the present attention of the driver (e.g., the bird 224). The controller 210 may be configured to operate in a driver assist mode, wherein based on a determination of a mismatch between the learned salient feature and the current attention of the driver, the controller may produce an attention indication. In some implementations, the attention indication may comprise an audible and/or light alarm (e.g., a beep, a flashing light). In some implementations, wherein the windshield 206 may comprise a HUD, the alarm may comprise an indication visible on the windshield (e.g., a flashing marker 228 of an area, which may be a spot, contour, arrow, etc.) at, around, or next to the location indicating the driver's target of attention for the task (e.g., safe navigation), a flashing representation of the pedestrian, and/or other attention indication). Various other attention indications may be utilized in order to assist the driver, e.g., using an in vehicle display. The controller may be configured to project plane of the driver's gaze onto the display plane (e.g., HUD, in vehicle display, and/or other display means). The gaze plane may be configured perpendicular to the line of sight (e.g., shown by the line 606 in FIG. 6A).

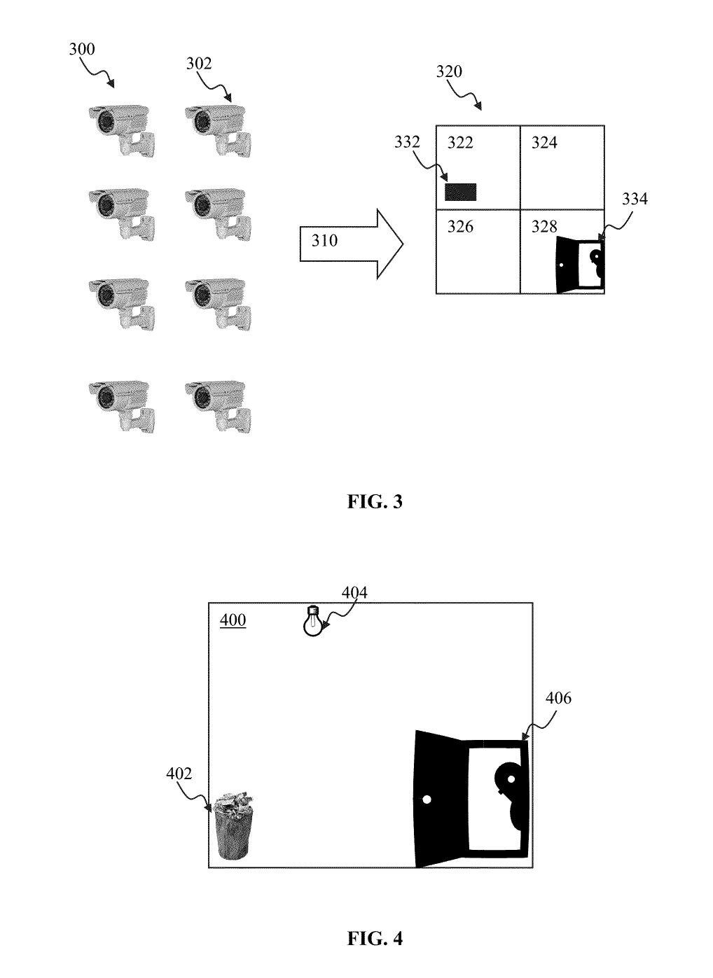

In some implementations of robot assisted vehicle navigation, an alert may be generated when the driver fails to gaze at an area within a certain range (e.g. 5 degrees of arc) from the high-saliency location for and/or within a certain period of time (e.g. selected from the range between 0.5 sec to 5 sec, 1 sec). It will be recognized by those skilled in the arts that these values are exemplary and may be modified in accordance with requirements of a specific application. For example, when surroundings change rapidly (e.g., high speed train, highway vehicle navigation) the inattention interval may be shortened; when surroundings change slower (e.g., boat navigation) the inattention interval may be widened (e.g., up to minutes). FIGS. 3-4 illustrate use of gaze-based saliency maps for training a controller in a surveillance application. FIG. 3 depicts use of an adaptive gaze based saliency maps methodology by a surveillance system, in accordance with one or more implementations. The surveillance system of FIG. 3 may comprise a plurality of security cameras 300. Individual cameras (e.g., 302) may comprise any applicable camera technology (e.g., artificial retinal ganglion cells (RGCs), a charge coupled device (CCD), an active-pixel sensor (APS), and/or other sensors) configured to provide color and/or gray scale pixel frames, and/or encoded spiking output. Camera output 310 (either raw and/or compressed) may be provided to a display apparatus 320. The display apparatus 320 may comprise a plurality of displays, e.g., 322, 324, 326, 328 shown in FIG. 3. In some implementations wherein a number of displays of the apparatus 320 may be smaller than number of cameras 302 the apparatus 320 may employ a multiplex display method wherein a subset of camera streams (e.g., four streams in FIG. 3) may be displayed at a given time interval t1. At a subsequent time interval t2, one or more streams of the subset may be replaced by another stream not displayed at interval t1. Various multiplexing method may be employed, e.g., full or partial round robin, n-wise grouping, wherein streams from given n-cameras may be assigned to be displayed contemporaneously with one another, and/or other display configurations.

Individual displays of the apparatus 320 may comprise visual scene characterized by one or more objects (e.g., object 332 in display 322 and object 338 in display 328). During training, an operator may observe information that may be present on the display 320. A gaze tracking component (not shown) may be utilized in order to obtain gaze information of the trainer during these observations. The gaze information may indicate that some scenes (e.g., an image of a person 338 appearing in a doorway) may attract additional attention of the trainer, as compared to other objects, e.g., 332. The additional attention may be characterized by one or more of frequency and/or duration of the trainer's gaze falling onto the object 338.

FIG. 4 depicts an exemplary sensory frame usable for training an adaptive controller to determine a saliency map using gaze information, in accordance with one or more implementations. The frame 400 of FIG. 4 may correspond to a frame on one of displays (e.g., 322, 324, 326, 328) of FIG. 3. The frame 400 may comprise representations of one or more objects, e.g., 402, 404, 406. The controller may be trained to analyze data in the frame 400 in order to determine saliency map. Object saliency (e.g., importance of the object relative other objects) may depend on the task. In some implementations of premises security, the trainer may select an open door and/or a presence of a person (406) as being salient. In some implementations of premises safety, the trainer may select an unlit and/or missing light bulb (404) as being salient. In some implementations of premises cleaning security, the trainer may select an open door, a presence of a person (406) as being salient. During training, the controller may be configured to learn determination of saliency maps, wherein a given saliency map may be associated with respective task. During operation, the controller may user the map that is associated with the task. It will be recognized by those skilled in the arts that saliency map construction methodology may be employed using live feed wherein output 310 may comprise real-time data provided by the apparatus 300 in FIG. 3; and/or offline training using pre-recorded data. In some implementations of offline training, a single display may be employed to cycle through a plurality of camera feeds.

In some implementations, the system may be trained first (on-line or off-line) and then used to augment and/or replace the human operator. In some implementations, the system may continue learning from the gaze direction of the human operator during use. In one or more implementations, the learning may comprise continuous learning (always learn), periodic training (e.g., based on performance), and/or during special sessions of additional training and/or error correction.

The system may operate, in some implementations, as autonomous alarm system, for example when a suspected intruder, fire, flooding, animal, and/or another anomaly may be detected. Upon detecting the anomaly, the system may alert the human operator.

In some implementations, the system may activate, orient, turn, focus, record, and/or otherwise operate additional devices (e.g. cameras, lights, deterrent measures etc.) in or to the locations where particular salient events or objects are detected, or in the regions of increased salience in general.

In some implementations, the system may present the locations of increased salience on the display screen(s) more often, and/or for longer, and/or in higher quality (e.g. resolution, refresh rate, color) and/or on the specially designated display screens. In some implementations, the system may send a remotely operated or autonomous vehicle to the location of high salience.

FIG. 5A illustrates an adaptive controller configured to learn detection of salient features in sensory input using gaze of a trainer, in accordance with one or more implementations. The controller may utilize the trainer's gaze as a teaching input, and the sensory input and the context as data inputs, to learn to predict the saliency map from the sensory input and the context. The controller 500 of FIG. 5A may be employed in a robot-assisted vehicle navigation, e.g., the vehicle described with respect to FIG. 2 and/or surveillance system described with respect to FIGS. 3-4. The controller 500 may assist the driver during route navigation (e.g., by providing an alert related to an upcoming hazard), be used in training of drivers (novice and/or experienced), augment the driver (e.g., execution a collision prevention action responsive to detection of an obstacle), alert the driver responsive to detection loss of alertness (e.g., blind area), and/or used in other applications. In some implementations, the controller 500 may be embodied within an autonomously operated vehicle.

The controller apparatus 500 may comprise a gaze processing component 506 configured to determine spatial and/or temporal parameters of trainer's gaze data 502. The gaze data 502 may be provided using any applicable methodology including those described above with respect to FIGS. 1-2. The gaze data 502 may be utilized by the component 506 in order to determine attention of the trainer (e.g., saliency map) using any applicable methodologies including those described with respect to FIGS. 6A-7 below.

FIG. 6A illustrates saliency determination using a Gaussian spatial kernel, in accordance with one or more implementations. The frame 600 may represent an image frame (e.g., 400 in FIG. 4). Present gaze direction of a trainer and/or of a user 602 may be indicated by a broken line 606. The present gaze information may be characterized by an area 604 within the image frame. In one or more implementations, the area may be characterized by a spatial kernel characterized by a circular, rectangular, elliptical, irregular, and/or other perimeter shape. The kernel associated with the area 604 may be characterized by a spatial weighting distribution w(Δt), e.g., illustrated by curves 612, 614 in FIG. 6A. Gaze directions falling within the area 604 over successive frames 600 may be weighted by the kernel to obtain saliency distribution associated with that portion of the frame.

FIG. 6B illustrates saliency determination using a time history of gaze information, in accordance with one or more implementations. Present gaze direction of a trainer and/or of a user 622 may be indicated by a solid line 630. The gaze area 628 may correspond to an image frame (e.g., 400 in FIG. 4) being presently analyzed. Gaze directions corresponding to preceding frames may be indicated by broken lines 632 in FIG. 6B. The gaze information may be characterized by an area 628 within the image frame. In one or more implementations, the area 628 may comprise the kernel described above with respect to FIG. 6A above. The gaze area may transition spatially (as shown by circular areas e.g., 624, 626, 628 in FIG. 6B) along a trajectory 636 during when, e.g., observing an object transitioning across a view field. A temporal kernel may be applied to the gaze information associated with the trajectory 636. Curve 634 illustrates one implementation of temporal kernel configured to implement exponential decay (e.g., memory loss) as a function of time interval Δt between current frame time and time of a preceding frame. In some implementations, the spatial kernel Δw(Δr) of FIG. 6A may be combined with the temporal kernel Δw(Δt) of FIG. 6B to realize a spatio-temporal kernel Δw(Δt,Δr).

Saccades, or any rapid eye movement events, may be detected and time intervals near or around such events may be treated separately or discarded from subsequent processing. Lighting (such as IR light source or sources) may be used to improve gaze detection. Additional equipment may be used to facilitate gaze detection as well as record, for example, the driver head position, as required for reliable extraction of the saliency map and the context data.

In some implementations, the saliency map may be acquired iteratively or cumulatively, over multiple passes or multiple presentations of the stimuli. For example, one or more human trainers may view multiple instances of the same video stream, simultaneously or sequentially. Gaze of the multiple trainers may be determined. The gaze data may be filtered, pooled, averaged, and/or otherwise processed to produce a single saliency map associated with the video input. The saliency map acquired iteratively or cumulatively, as described here, may comprise a statistical description of salience at a given location (with respect to sensory input) at a given time. Examples of such a statistical description may comprise a probability distribution, a confidence interval, a mean, and/or a standard deviation of the salience as a function of position and/or time.

FIG. 7 illustrates saliency determination using a spatial gaze distribution in an iterative offline learning process, in accordance with one or more implementations. Panel 700 in FIG. 7 may represent spatial extent of raw and/or processed sensory input (e.g., 504 in FIG. 5A and/or frame 400 in FIG. 4). Panel 700 may be characterized by presence of one or more objects. Areas 702, 704, 706 may represent areas of attention by the trainer associated with a sequence of sensory frames. The area 706 may correspond to a greater saliency compared to the areas 704, 706. Saliency of the areas 702, 704, 706 may be determined based on the gaze information 502 using ay applicable methodology, e.g., described above with respect to FIGS. 6A-6B.

Returning now to FIG. 5A, the controller apparatus 500 may comprise a component 510 configured to operate an adaptive predictor process. The process of the component 510 may be configured to determine one or more salient features on sensory input 504 using gaze of the trainer. Various predictor methodologies may be utilized, including, e.g., such as described in U.S. patent application Ser. No. 13/842,562 entitled “ADAPTIVE PREDICTOR APPARATUS AND METHODS FOR ROBOTIC CONTROL”, filed Mar. 15, 2013, and/or Ser. No. 13/842,583 entitled “APPARATUS AND METHODS FOR TRAINING OF ROBOTIC DEVICES”, filed Mar. 15, 2013, each of the foregoing being incorporated herein by reference in its entirety.

The sensory input 504 may comprise one or more of stream of pixels, output of a sensing component (e.g., radio, pressure, light wave receiver) and/or other data source. In some implementations, the component 510 may be operated to detect one or more objects in an image frame of the sensory input 504 (e.g., objects 402, 404, 406 in frame 400 in FIG. 4).

Output 512 of the component 506 may be provided to the component 510. In some implementations, the component 510 may receive input 516 related to the task and/or operating parameters of the robotic system being used with the apparatus 500. The input 516 may comprise one or more of state parameters of a vehicle (e.g., motion parameters, lane, position, orientation, speed, break activation, transmission state), robotic platform configuration (e.g., manipulator size and/or position), available power, and/or other parameters. In some implementations, the input 516 may comprise one or more task parameters, e.g., route type (faster time, shorter route), mission type (e.g., surveillance, delivery), environmental conditions (wind, rain), a time history of executed actions, and/or other characteristics. The sensory information 504 and the input 516 may be collectively referred to as the context.

The learning process of the component 510 may be configured to determine association between the context and the saliency indication 512 provided by the trainer. The association may be learned by means of (but not restricted to) a lookup table update, Markov model update, a single- and/or a multilayer perceptron using backpropagation and/or other learning rule, a feed-forward, a recurrent neural network using gradient descent, Nelder-Mead, Monte Carlo, and/or other update methods (e.g., Boltzmann machine(s)). Sensory feature extraction—to provide relevant sensory features for the association—may be carried out by means of (but not restricted to) singular value decomposition (SVD), principal component analysis (PCA), sparse PCA, self-organizing map, feed-forward and/or recurrent neural network, convolutional neural network, hierarchical temporal memory, Boltzmann machine(s), and/or other learning approach. Multiple successive and/or recurrently-connected layers of feature extraction, working on similar and/or increasingly larger spatial and temporal scales, may be utilized, with fixed or adaptive non-linearity and connectivity patterns between the layers. Feature extraction may utilize continuity of the visual input to detect object boundaries and to learn properties and invariances of object motion. Some context features may also undergo feature extraction and dimensionality reduction using (but not restricted to) one of the methods mentioned above.

During training, the component 510 may utilize the trainer's gaze to assign a saliency indication (a score) to one or more objects that may be detected in the sensory input 504. In some implementations, the saliency indication may be assigned to areas of the frame that may be void of objects in a given frame. By way of an illustration of a vehicle navigation, when the vehicle (e.g., 110 in FIG. 1) approaches an intersection or a pedestrian crosswalk, an area proximate left and/or right of the windshield (e.g., 206 in FIG. 2) and/or in image frame obtained by the camera 108 in FIG. 1) may correspond to a high attention (salient) areas as indicated by the trainer. In another example, an area characterized in a prior frame may be considered as salient in a subsequent image even though there may not be an object in the area of the subsequent frame (e.g., due to an obstruction and/or acquisition noise).

The association between the between the context and the saliency indication 512 may comprise assigning a score to an object (e.g., 334 in FIG. 3 and/or 406 in FIG. 4) based on the value of the trainer's gaze duration and/or frequency associated with the object. By way of an illustration, responsive to a determination that the trainer's gaze is preferentially applied to the object 334 in FIG. 3, the object 334 may be assigned higher saliency value compared to other objects that may occur.

Output 520 of the process 510 may comprise one or more salient features being determined in the sensory input 504. Saliency information 512 may be utilized in order to adapt the learning process of the component 510. The output 520 may be used to determine a teaching signal 524. The teaching signal 524 may be utilized by the component 510 in order to adapt the learning process. The learning process adaptation may comprise determination of a match (and/or of an error) between (i) one or more features being detected by the component 510 in the input 504 and (ii) the saliency indication 512. In one or more implementations, the learning process adaptation may comprise error back propagation, e.g., described in U.S. patent application Ser. No. 14/054,366 entitled “APPARATUS AND METHODS FOR BACKWARD PROPAGATION OF ERRORS IN A SPIKING NEURON NETWORK”, filed Oct. 15, 2013, the foregoing being incorporated herein by reference in its entirety.

The configuration of the trained learning process may be stored as indicated by arrow 518 in FIG. 5A. In one or more implementations of artificial neuron network, the trained configuration may comprise an array of network efficacies (e.g., synaptic weights). In one or more implementations, trained configuration may be loaded into the component 510 (e.g., in order to resume learning and/or improve operation of the component 510).

FIG. 5B illustrates operation of an adaptive controller configured to determine an output configured based on a salient feature determination and/or user gaze, in accordance with one or more implementations. The controller may be trained to predict the saliency map from the sensory input and the context. During training, the controller may compare the predicted saliency map to the gaze direction/history of the gaze direction/saliency map of the operator. During operation, the previously trained controller may be capable of predicting the saliency map from the sensory input and the context. The controller may be configured to generate an alert e.g., upon determining that the operator does not gaze at a target location. The controller 540 of FIG. 5B may be employed in a robot-assisted vehicle navigation, e.g., the vehicle described with respect to FIG. 2 and/or surveillance system described with respect to FIGS. 3-4. The controller 540 may be used to assist the driver during route navigation (e.g., by providing an alert related to an upcoming hazard), be used in training of drivers (novice and/or experienced), augment the driver (e.g., execution a collision prevention action responsive to detection of an obstacle), alert the driver responsive to detection loss of alertness (e.g., blind area), and/or other applications. In some implementations, the controller 540 may be embodied (e.g., as a software, a hardware component, and/or a combination thereof) within a control system of an autonomously operated vehicle.

The controller apparatus 540 may comprise a gaze processing component 546 configured to determine spatial and/or temporal parameters of trainer's gaze data 542. The gaze data 542 may be provided using any applicable methodology including those described above with respect to FIGS. 1-2. In some implementations, the gaze data 542 may be at time intervals (e.g., 25 frames per second). The collected gaze snapshots data may be spatially and/or temporally (e.g., over several snapshots) combined by the component 546 in order determine to persistent gaze of the trainer (saliency map) using any applicable methodologies including those described with respect to FIGS. 6A-7.

The controller apparatus 540 may comprise processing component 550 configured to determine a salient feature in sensory input 544. The sensory input 544 may comprise one or more of stream of pixels, output of a sensing component (e.g., radio, pressure, light wave receiver) and/or other source of sensory data. In some implementations, the component 550 may be operated to detect one or more objects in an image frame of the sensory input 544 (e.g., objects 402, 404, 406 in frame 400 in FIG. 4).

The component 550 may configured to operate an adaptive predictor process configured to determine one or more salient features on sensory input 544. In some implementations, the predictor operation of the component 550 may be configured based on sensory information 556 related to the task and/or operating parameters of the robotic system being used with the apparatus 540. The input 556 may comprise one or more of state parameters of a vehicle, e.g., motion parameters, (lane, position, orientation, speed), robotic platform configuration (e.g., manipulator size and/or position), available power and/or other parameter characterizing the vehicle. The input 556 may comprise one or more task parameters, e.g., route type (faster time, shorter route), mission type (e.g., surveillance, delivery), environmental conditions (wind, rain), a time history of executed actions, and/or other characteristics of the task being executed by the vehicle. The sensory information 544 and the input 556 may be collectively referred to as the context.

Various predictor methodologies may be utilized, including, e.g., such as described in U.S. patent application Ser. No. 13/842,562 entitled “ADAPTIVE PREDICTOR APPARATUS AND METHODS FOR ROBOTIC CONTROL”, filed Mar. 15, 2013, and/or Ser. No. 13/842,583 entitled “APPARATUS AND METHODS FOR TRAINING OF ROBOTIC DEVICES”, filed Mar. 15, 2013, each of the foregoing being incorporated herein by reference in its entirety.

The process of the component 550 may be comprise the adaptive predictor process trained using, trainer's gaze methodology, e.g., as described above with respect to FIG. 5A. Trained predictor configuration may be loaded into the learning process of the component 550. In one or more implementations of artificial neuron network, the trained configuration may comprise an array of network efficacies (e.g., synaptic weights).

The predictor process of the component 550 may be configured to produce output 552 based on the context 544, 566. In some implementations of vehicle navigation, the output 552 may comprise an indication for the driver determined based on a determination of a salient feature associated with the context. By way of an illustration, the apparatus 540 may be configured to provide a warning to the driver (via the indication 552) based on detecting a pedestrian proximate an intersection. The apparatus 540 may be configured to indicate an area of potential hazard (attention) while approaching an intersection, executing a turn and/or other. In one or more implementations, the indication may comprise an audible alarm, an indication visible on a vehicle windshield (e.g., a flashing marker pointing towards right corner, a flashing rectangle over the crosswalk). Various other attention indications may be utilized in order to assist the driver, e.g., using an in vehicle display, a warning light, and/or other attention means.

In one or more implementations of data processing (e.g., data mining, surveillance, survey, exploration and/or other data processing applications) the output 552 may be configured based on detecting an object/feature in one or more portion of the input 544 that are deemed salient (e.g., frame 328 in FIG. 3), and/or configured to convey absence of an object in sensory input 544. By way of an illustration, while investigating a robbery/break-in, surveillance camera feeds may be automatically proceed by trained apparatus 540 configured to detect an intruder, open door, presence of extraneous objects and/or other objects and/or features. By way of an illustration of building maintenance, surveillance camera feeds may be automatically proceed by trained apparatus 540 configured to detect refuse, furniture in disarray, water leaks, and/or other premises characteristics. The output 552 may comprise, e.g., a value, a message, a logic state of a software variable, signal of an integrated circuit pin, and/or other indication means.

In some implementations, output 548 of the gaze processing component 546 may be provided to the component 550, for example for the purpose of comparison. In one or more implementation, the component 550 may be configured to compare the instant direction, direction history, and/or saliency map of the driver's gaze (input 548) with the predicted saliency map generated by component 550 based on the sensory and context inputs 544, 556. A mismatch between the actual and the predicted saliency map may be reported by the component 550 via output 552, for example in the form of an alert.

In some implementations, the output 548 of the gaze processing component 546 may be provided to the component 550, for the purpose of continued training of the salience map predictor. The component 550 may uses the saliency map of the driver's gaze (input 548) to improve the prediction of the saliency map generated by component 550 based on the sensory and context inputs 544, 556. For example, a mismatch between the actual and the predicted saliency map (as reported by output 552, or as represented internally in the component 550) may be used as a teaching signal for the component 550, similar to the implementation of FIG. 5A. This continued training process may, in some implementations, proceed with decreased learning rate compared to the training process in FIG. 5A. This continued training process may take place concomitantly with the routine operation described in the previous paragraph. In some implementations, the continued training may occur based on an indication provided to the system 540 via a user interface component. By way of an illustration, during operation of the robot assist vehicle by an experienced driver, the driver may be deemed to allocate his (her) gaze correctly. Therefore, the teaching signal may be appropriate vast majority of the time, and further improve the predictor accuracy. Substantial mis-directions of driver's gaze may occur infrequency, and consequently may not affect detrimentally the accuracy of the saliency map predictor of component 550.

In one or more implementations of robot assisted operation (e.g., novice driver training), the apparatus 540 may be configured to determine present attention map of the user using the current gaze information 548 provided by the gaze processing component 546. The component 550 may compare the present attention map with the saliency map associated with the present context (e.g., 544, 556). Responsive to a detection of a mismatch between the current attention of the user (the current map) and the target attention (as indicated by output of the predictor process) the component 550 may provide the output 552. In some implementations, the attention indication may comprise an audible and/or light alarm (e.g., a beep, a flashing light). In some implementations, wherein the windshield 206 may comprise a HUD, the output 520 may comprise an indication visible on the windshield (e.g., a flashing marker proximate pedestrian 228, a flashing representation of the pedestrian, and/or other output indication). Various other attention indications may be utilized in order to assist the driver, e.g., using an in vehicle display.

In one or more implementations, the output 552 may be produced based on detecting an absence of attention (e.g., a low current user saliency score) associated with a given area (e.g., display 304 in FIG. 3). Absence of attention may be due to a user failing to look/glance at the given area for a period of time (e.g., corresponding to a number N of input frames. In vehicle navigation implementations, N may be selected to cover between 0.1 and 2 seconds. Those skilled in the arts may appreciate that the numbers cited above represent an exemplary time period that may be adjusted or varied depending on the stimulus, context, current saliency, and saliency mismatch. For example, at higher speeds of vehicle motion, at shorter ranges between the vehicle and the object, and at higher saliency mismatch values it would be beneficial to decrease the said period and/or to produce a stronger alarm signal.

A variety of methodologies may be used for detecting the mismatch between the predicted saliency and the current gaze. In some implementations, the mismatch may be determined based on a discrepancy between the coordinates of user most salient area and coordinates of the reference attention area. In one or more implementations, the discrepancy may be based on a distance measure, a norm, a maximum absolute deviation, a signed/unsigned difference, a correlation, a point-wise comparison, and/or a function of an n-dimensional distance (e.g., a mean squared error).

In one or more implementations, the mismatch may be determined based on a comparison of a saliency value of an area in the reference saliency map that corresponds to most salient area in the current saliency map. By way of an illustration, for the saliency value of 1 in the reference map, associated with the area corresponding to the pedestrian 228 in FIG. 2, a value of less than one in the current map for that area may indicate discrepancy. In some implementations, the mismatch may be determined based on a comparison of a saliency value of an area in the current saliency map that corresponds to most salient area in the reference map. By way of an illustration, for the saliency value of 1 in the current map, associated with the area corresponding to the bird 224 in FIG. 2, a value of less than one in the reference map for that area may indicate discrepancy.

Discrepancy between saliency values may be determined using any applicable methodologies including, e.g., a distance D between the current x and the reference saliency x^{r} may be determined as follows:

D=(x^{r}−x), (Eqn. 1)

D=sign(x^{r})−sign(x), (Eqn. 2)

D=sign(x^{r}−x). (Eqn. 3)

In one or more implementations of online learning, the predictor process of the component 550 may be updated using the discrepancy, illustrated by a broken line 554 in FIG. 5B. The learning process adaptation may comprise error back propagation, e.g., described in U.S. patent application Ser. No. 14/054,366 entitled “APPARATUS AND METHODS FOR BACKWARD PROPAGATION OF ERRORS IN A SPIKING NEURON NETWORK”, filed Oct. 15, 2013, the foregoing being incorporated supra.

The algorithm for computation of the mismatch between the predicted saliency and the current saliency may itself be trainable or adaptable. In one or more implementations, this algorithm may be trained using an approach including one or more of a commercial or purpose-built driving simulator, a computer simulation, a virtual reality environment, and/or other approaches. In some implementations, the learning may be self-supervised (e.g., to optimize the said algorithm to minimize the number of simulated traffic accidents per unit time or per unit road length). In some implementations, the learning may be supervised. For example, an expert driver ‘A’ may observe another driver ‘B’ operate the driving simulator. The driver ‘A’ may observe the driving simulation, the saliency map predicted by component 550, and the current saliency map of the driver ‘B’, e.g. on the same or on separate screens. The driver ‘A’ may issue a signal (e.g. touch the screen, press a button, and/or click a mouse in the appropriate location) based on identifying a condition where issuing an alert may appropriate. Such a condition may be, for example, a misdirection of gaze of the driver ‘B’, and/or a mismatch between the saliency map predicted by component 550 and the current saliency map of the driver ‘B’. In some implementations, expert driver ‘A’ may rate (score) the output signals 552 according to their appropriateness. Those skilled in the arts will appreciate that the teaching signal, as provided by the expert driver ‘A’, may in some cases be used not only to train the algorithm for computation of the mismatch between the predicted saliency and the current saliency, but also provide an additional teaching input to the saliency predictor in component 550.

FIG. 5C is a functional block diagram illustrating operation of an adaptive controller operable to determine a salient feature, in accordance with one or more implementations.

FIG. 5C illustrates operation of an adaptive controller apparatus operable to determine a salient feature, in accordance with one or more implementations. The controller 560 of FIG. 5C may be employed in a robot-assisted vehicle navigation, e.g., the vehicle described with respect to FIG. 2 and/or surveillance system described with respect to FIGS. 3-4. The controller 560 may be used to assist the driver during route navigation (e.g., by providing an alert related to an upcoming hazard), be used in training of drivers (novice and/or experienced), augment the driver (e.g., execution a collision prevention action responsive to detection of an obstacle), alert the driver responsive to detection loss of alertness (e.g., blind area), and/or other applications of robotic assistance. In some implementations, the controller 560 may be embodied (e.g., as a software, a hardware component, and/or a combination thereof) within a control system of an autonomously operated vehicle.

The apparatus 560 may be configured to determine a salient feature in sensory input 564. The sensory input 564 may comprise one or more of stream of pixels, output of a sensing component (e.g., radio, pressure, light wave receiver) and/or other sensory data. In some implementations, the controller 560 may be operated to detect one or more objects in an image frame of the sensory input 564 (e.g., objects 402, 404, 406 in frame 400 in FIG. 4).

The component 560 may configured to operate an adaptive predictor process configured to determine one or more salient features on sensory input 564. In some implementations, the predictor operation of the controller 560 may be configured based on sensory information 556 related to the task and/or operating parameters of the robotic system being used with the apparatus 560. The input 566 may comprise one or more of state parameters of a vehicle, e.g., motion parameters, (lane, position, orientation, speed), robotic platform configuration (e.g., manipulator size and/or position), and/or available power. The input 566 may comprise one or more task parameters, e.g., route type (faster time, shorter route), mission type (e.g., surveillance, delivery), environmental conditions (wind, rain), a time history of executed actions, and/or other characteristic. The sensory information 564 and the input 566 may be collectively referred to as the context.

The controller 560 may operate an adaptive predictor process trained using, trainer's gaze methodology, e.g., as described above with respect to FIG. 5A. Trained predictor configuration may be loaded in to the learning process of the controller 560. In one or more implementations of artificial neuron network, the trained configuration may comprise an array of network efficacies (e.g., synaptic weights).

The predictor process of the controller 560 may be configured to produce output 572 based on the context 564, 566. In some implementations of vehicle navigation, the output 572 may comprise an indication for the driver determined based on a determination of a salient feature associated with the context. By way of an illustration, the apparatus 560 may be configured to provide a warning to the driver (via the indication 572) based on detecting a pedestrian proximate an intersection. The apparatus 560 may be configured to indicate an area of potential hazard (area of attention/saliency) while approaching an intersection, executing a turn, and/or other actions. In one or more implementations, the indication may comprise an audible alarm, an indication visible on a vehicle windshield (e.g., a flashing marker pointing towards right corner, a flashing rectangle over the crosswalk, and/or other pointing means). Various other attention indications may be utilized in order to assist the driver, e.g., using an in vehicle display, a warning light, and/or other indications.

In one or more implementations of data processing (e.g., data mining, surveillance, survey, exploration and/or other data processing applications) the output 572 may be configured based on detecting an object/feature in one or more portion of the input 564 that are deemed salient (e.g., frame 328 in FIG. 3), and/or configured to convey absence of an object in sensory input 564. By way of an illustration, while investigating a robbery/break-in, surveillance camera feeds may be automatically proceed by trained apparatus 540 configured to detect an intruder, open door, presence of extraneous objects and/or other premises features. By way of an illustration of building maintenance, surveillance camera feeds may be automatically proceed by trained apparatus 560 configured to detect refuse, furniture in disarray, water leaks, an/or other premises conditions. The output 572 may comprise one or more of a value, a message, a logic state of a software variable, a signal on an integrated circuit pin, and/or other output means.

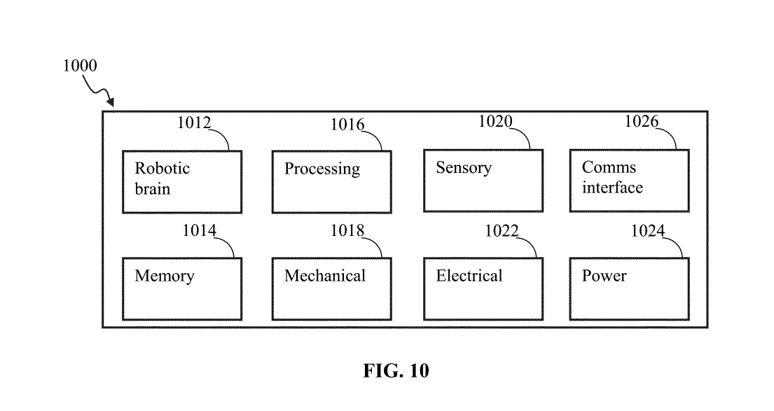

FIG. 10 is a functional block diagram illustrating a computerized controller apparatus for implementing, inter alia, training utilizing gaze-based saliency maps methodology in accordance with one or more implementations.

The apparatus 1000 may comprise a processing module 1016 configured to receive sensory input from sensory block 1020 (e.g., camera 108 in FIG. 1). In some implementations, the sensory module 1020 may comprise audio input/output portion. The processing module 1016 may be configured to implement signal processing functionality (e.g., object detection).

The apparatus 1000 may comprise memory 1014 configured to store executable instructions (e.g., operating system and/or application code, raw and/or processed data such as raw image frames and/or object views, teaching input, information related to one or more detected objects, and/or other information).

In some implementations, the processing module 1016 may interface with one or more of the mechanical 1018, sensory 1020, electrical 1022, power components 1024, communications interface 1026, and/or other components via driver interfaces, software abstraction layers, and/or other interfacing techniques. Thus, additional processing and memory capacity may be used to support these processes. However, it will be appreciated that these components may be fully controlled by the processing module. The memory and processing capacity may aid in processing code management for the apparatus 1000 (e.g. loading, replacement, initial startup and/or other operations). Consistent with the present disclosure, the various components of the device may be remotely disposed from one another, and/or aggregated. For example, the instructions operating the haptic learning process may be executed on a server apparatus that may control the mechanical components via network or radio connection. In some implementations, multiple mechanical, sensory, electrical units, and/or other components may be controlled by a single robotic controller via network/radio connectivity.

The mechanical components 1018 may include virtually any type of device capable of motion and/or performance of a desired function or task. Examples of such devices may include one or more of motors, servos, pumps, hydraulics, pneumatics, stepper motors, rotational plates, micro-electro-mechanical devices (MEMS), electroactive polymers, shape memory alloy (SMA) activation, and/or other devices. The sensor devices may interface with the processing module, and/or enable physical interaction and/or manipulation of the device.

The sensory devices 1020 may enable the controller apparatus 1000 to accept stimulus from external entities. Examples of such external entities may include one or more of video, audio, haptic, capacitive, radio, vibrational, ultrasonic, infrared, motion, and temperature sensors radar, lidar and/or sonar, and/or other external entities. The module 1016 may implement logic configured to process user queries (e.g., voice input “are these my keys”) and/or provide responses and/or instructions to the user.

The electrical components 1022 may include virtually any electrical device for interaction and manipulation of the outside world. Examples of such electrical devices may include one or more of light/radiation generating devices (e.g. LEDs, IR sources, light bulbs, and/or other devices), audio devices, monitors/displays, switches, heaters, coolers, ultrasound transducers, lasers, and/or other electrical devices. These devices may enable a wide array of applications for the apparatus 1000 in industrial, hobbyist, building management, medical device, military/intelligence, and/or other fields.

The communications interface may include one or more connections to external computerized devices to allow for, inter alia, management of the apparatus 1000. The connections may include one or more of the wireless or wireline interfaces discussed above, and may include customized or proprietary connections for specific applications. The communications interface may be configured to receive sensory input from an external camera, a user interface (e.g., a headset microphone, a button, a touchpad, and/or other user interface), and/or provide sensory output (e.g., voice commands to a headset, visual feedback, and/or other sensory output).

The power system 1024 may be tailored to the needs of the application of the device. For example, for a small hobbyist robot or aid device, a wireless power solution (e.g. battery, solar cell, inductive (contactless) power source, rectification, and/or other wireless power solution) may be appropriate. However, for building management applications, battery backup/direct wall power may be superior, in some implementations. In addition, in some implementations, the power system may be adaptable with respect to the training of the apparatus 1000. Thus, the apparatus 1000 may improve its efficiency (to include power consumption efficiency) through learned management techniques specifically tailored to the tasks performed by the apparatus 1000.

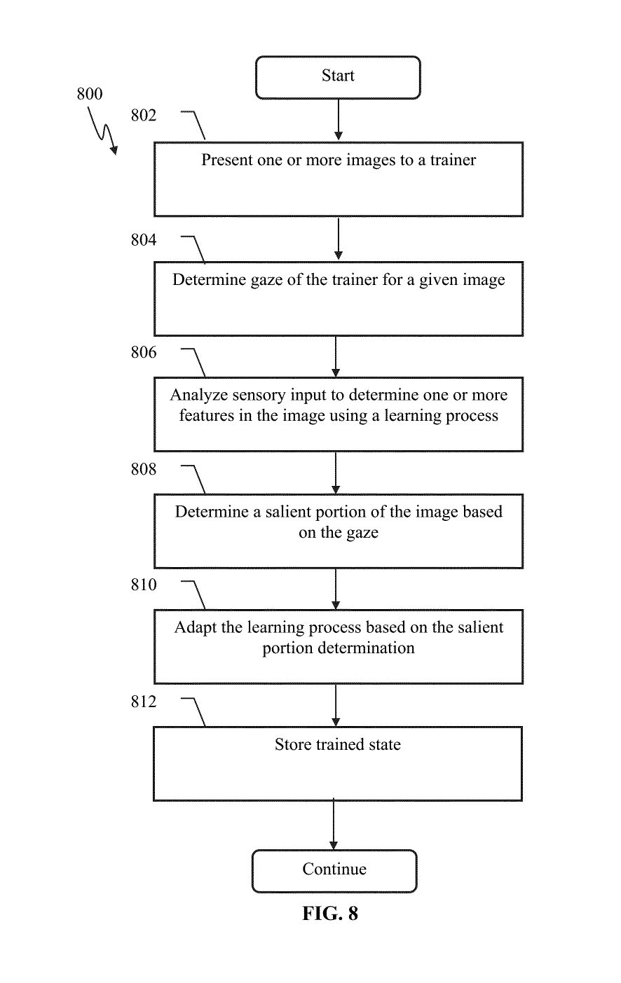

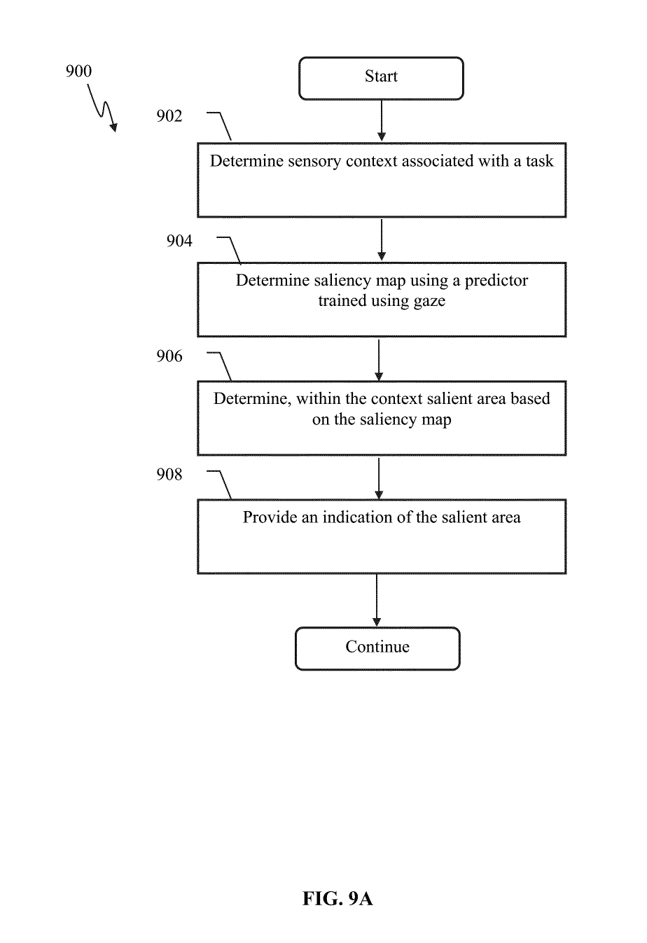

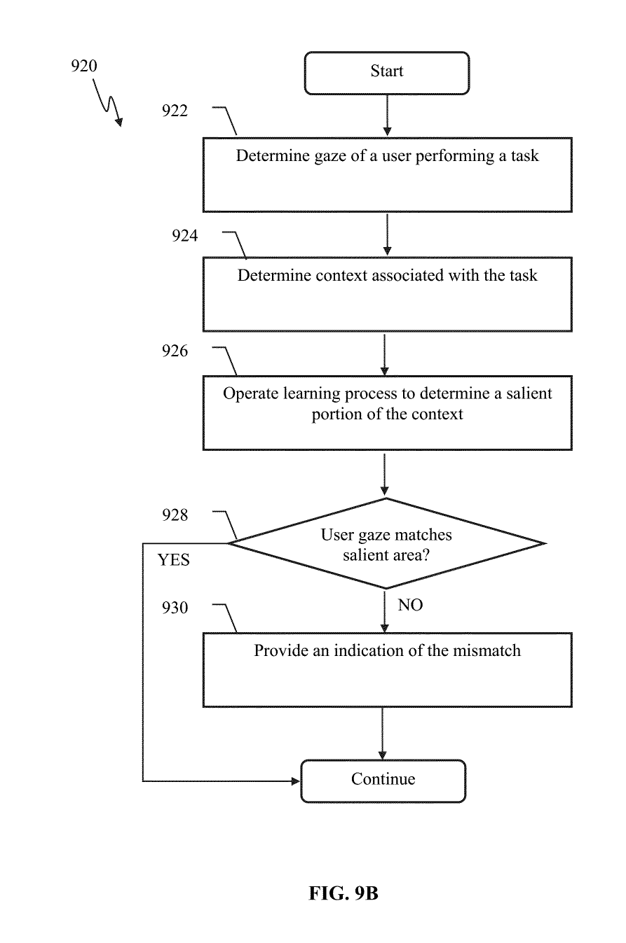

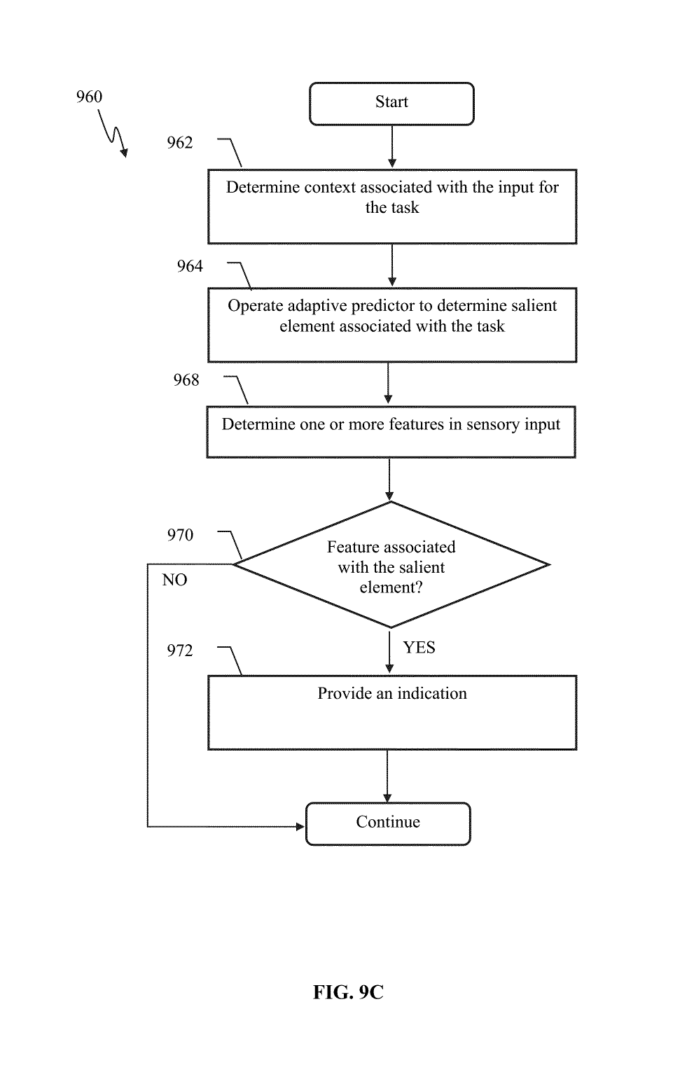

FIGS. 8-9C illustrate methods 800, 900, 920, 960 of determining and using gaze—based saliency maps for operating robotic and computerized devices. The operations of methods 800, 900, 920, 960 presented below are intended to be illustrative. In some implementations, method 800, 900, 920, 960 may be accomplished with one or more additional operations not described, and/or without one or more of the operations discussed. Additionally, the order in which the operations of method 800, 900, 920, 960 are illustrated in FIGS. 8-9C and described below is not intended to be limiting.

In some implementations, methods 800, 900, 920, 960 may be realized in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of methods 800, 900, 920, 960 in response to instructions stored electronically on an electronic storage medium. The one or more processing devices may include one or more devices configured through hardware, firmware, and/or software to be specifically designed for execution of one or more of the operations of methods 800, 900, 920, 960.

FIG. 8 illustrates a method of determining a saliency map based on gaze of a trainer, in accordance with one or more implementations. Operations of method 800 may be employed during training of e.g., controller 104 in FIG. 1 and/or apparatus 500 of FIG. 5A to perform a given task. Trainer's gaze pattern may be the task dependent and highly indicative the overt attention of the human performing the task. The gaze pattern (saccades, fixations, and/or smooth pursuit) may be converted into a dynamic heat-map of attention (also referred to as “importance map”).

At operation 802 one or more images may be presented to a trainer. In some implementations, such as navigation, object recognition, and/or obstacle avoidance, individual images may comprise a stream of pixel values associated with one or more digital frames. In one or more implementations (e.g., video, radar, sonography, x-ray, magnetic resonance imaging, LIDAR, and/or other types of sensing), the input may comprise electromagnetic waves (e.g., visible light, IR, UV, and/or other types of electromagnetic waves) entering an imaging sensor array. In some implementations, the imaging sensor array may comprise one or more of biological, biomimetic, or prosthetic photoreceptor, ocellus, ommatidium, retina, portion of a retina, retinal neuron, retinal or retina-like neural network, retinal device, a charge coupled device (CCD), an active-pixel sensor (APS), and/or a combination thereof and/or other sensors. The one or more digital images and/or image frames may be received from a CCD camera via a receiver apparatus and/or downloaded from a file. The image may comprise, for example, a two-dimensional matrix of RGB values refreshed at a 25 Hz frame rate. It will be appreciated by those skilled in the arts that the above image parameters are merely exemplary, and many other image representations (e.g., bitmap, CMYK, HSV, HSL, grayscale, and/or other representations) and/or frame rates are equally useful with the present technology.

At operation 804 gaze of the trainer for a given image may be determined. Gaze determination may comprise any applicable commercial and/or custom-built gaze tracking methodologies. In some implementations non-contact, optical methodologies may be employed in order to detect eye motion of the trainer such as, e.g., described above with respect to FIG. 1. In one or more implementations the attention gaze information may be obtained using live image in real time and/or recoded video. In some implementations, the saliency map may be stored for individual image frame presented to the trainer at operation 802 or may be accumulated over a plurality of image frames using, e.g., a weighted average, a running mean, a block average, and/or other operations.

At operation 806 sensory input may be analyzed by a learning process in order to determine one or more features in the image. In one or more implementation, individual ones of the detected features may correspond to one or more of an edge, a color, an edge or plurality of edges; a surface; a color, brightness, hue, or reflectance; a texture; an object; a change or difference in a certain area (e.g. a traffic light); a motion or optic flow (e.g. looming, coherent movement, rotation); an event (e.g. a dog starting to run or a car swerving) and so on, as well as combinations thereof. It will be appreciated by the skilled in the arts that the stimulus features in many cases may form a hierarchy, with more complex features comprising a plurality of simpler features occurring in spatial and temporal proximity. At operation 806, the learning process may utilize features of all levels of complexity, and/or preferentially or exclusively the higher-complexity features (e.g. utilize preferentially the representations of objects—cars, pedestrians—as a whole, compared to the representations of their component features such as wheels or ears). It will also be appreciated by the skilled in the arts that the objects of highest salience are likely not the objects that are shiniest, brightest, or have the most edges or other low-level features. Rather, the objects or features of highest salience are the objects or features that are most likely to have a direct impact on the intended activity (task). For example, when the apparatus is used as illustrated in FIG. 1, the dog is far more salient than the bird (regardless of how brightly colored the bird plumage may be) as the dog is approaching the intended path of the vehicle. By contrast, when the apparatus is trained and used for bird-watching (for example to monitor the migratory or endangered species), a bird has a higher saliency than a dog. In some implementations, the sensory input may comprise one or more state parameters of the robotic apparatus (e.g., motion parameters, (lane, position, orientation, speed), platform configuration (e.g., manipulator size and/or position), available power, and/or other parameters of the robot. The sensory input may comprise data characterizing task parameters, e.g., route type (faster time, shorter route), mission route (e.g., surveillance, delivery), state of the environment (e.g., object size, motion, location), environmental conditions (wind, rain), a time history of vehicle motions, and/or other characteristic.

At operation 808 a saliency parameter may be assigned to a frame portion associated with the trainer's gaze determined at operation 804. In some implementations, an increment method may be used wherein a counter associated with the frame portion may be incremented responsive to a detection of the gaze within the boundaries of the frame portion. In one or more implementation, a spatial and/or a temporal kernel may be used, e.g., as described above with respect to FIGS. 6A-7 above. In some implementations, the salient frame portion may be determined based on a maximum value of the trainer's instant gaze; spatially averaged gaze, and/or area most frequently glanced upon by the trainer.

At operation 810 the learning process may be adapted based on the salient portion determination of operation 808. The learning process adaptation may comprise determination of a match (and/or of an error) between (i) one or more features being detected at operation 806 in the sensory input and (ii) the saliency portion determined based on the gaze of the trainer. By way of an illustration, the features determined at operation 806 may comprise a traffic light, a crosswalk sigh and a vehicle present at an opposing lane. In one or more implementations, the image portion being deemed by the trainer as salient may comprise one of the features detected at operation 806 (e.g., the traffic light). In some implementations, the image portion being deemed by the trainer as salient may be void of objects and comprise, e.g., a portion of the crosswalk area to the right of the vehicle (e.g., when the light is green the trainer may attempt to ensure that there are no pedestrians prepared to cross the street before proceeding ahead).

The learning process adaptation may comprise error back propagation, e.g., described in U.S. patent application Ser. No. 14/054,366 entitled “APPARATUS AND METHODS FOR BACKWARD PROPAGATION OF ERRORS IN A SPIKING NEURON NETWORK”, filed Oct. 15, 2013, incorporated supra.

At operation 812 the trained configuration of the learning process may be stored. In one or more implementations of artificial neuron network, the trained configuration may comprise an array of network efficacies (e.g., synaptic weights). In one or more implementations, sensory input (e.g., raw or processed camera output) and/or task-related context may be stored during operation 812.

In some implementations of, e.g., vehicle navigation, operations of method 800 may be employed using ambient visual input, wherein the trainer may be observing the environment (e.g., driving the vehicle) while performing the task (e.g., delivering an item). The gaze of the trainer may be related to a sensory input associated with the environment (e.g., digitized video frames of a camera 108 in FIG. 1) using any applicable methodologies.

FIG. 9A illustrates a method of operating a robotic device to perform a task using gaze based saliency maps, in accordance with one or more implementations.

At operation 902 sensory context associated with the task may be determined. In some implementations of robot assisted vehicle navigation, the context may comprise one or more of vehicle speed, position on the road, traffic lights/signs markings, presence of cars and/or pedestrians on and/or proximate the road, and/or other features.

At operation 904 saliency map associated with the context obtained at operation 902 may be determined. By away of an illustration, the context may comprise a representation of an intersection and/or a pedestrian cross walk. The saliency map may be configured to convey information related to areas of attention of the trainer while approaching the intersection/crosswalk during training. The saliency map may be determined using an adaptive process that may have been previously trained using gaze methodology, e.g., such as described above with respect to FIG. 8.

At operation 906 one or more salient areas may be determined based on the context and the saliency map. In some implementation, e.g., such as described above with respect to FIG. 2, the saliency map may indicate a left lower corner and/or a right lower corner of the frame as salient areas.

At operation 908 an indication of the salient area determined at operation 906 may be provided. In some implementations of vehicle navigation, the indication may comprise a voice announcement, e.g., “look right for pedestrians or vehicles”. In one or more implementations wherein the windshield may comprise a HUD, the indication may comprise a graphical representation (e.g., a text prompt, an arrow, an area boundary) configured to attract attention of the driver to the salient area.

FIG. 9B illustrates a method of using a trained adaptive controller to provide an attention indication to a user performing a task, in accordance with one or more implementations.

At operation 922 gaze of a user performing a task may be determined. Gaze determination may comprise any applicable commercial and/or custom-built gaze tracking methodologies. In some implementations non-contact, optical methodologies may be employed in order to detect eye motion of the trainer such as, e.g., described above with respect to FIG. 1. In one or more implementations the attention gaze information may be obtained using live image in real time and/or recoded video.

At operation 924 context associated with the task may be determined. In some implementations of robot assisted vehicle navigation, the context may comprise one or more of vehicle speed, position on the road, traffic lights/signs markings, presence of cars and/or pedestrians on and/or proximate the road, and/or other features. In one or more premises security and/or surveillance implementations, the context may comprise sensory information provided by, e.g., a plurality of cameras, proximity sensors, contact sensors, pressure, infrared, electromagnetic, and/or other sensors, a list of potential targets, and/or objects, premises layout, hours of operation, time of day/week, and or other parameters

At operation 926, a salient portion of the context (also referred to as the target attention area) may be determined based on operation of a previously trained learning process. In some implementations of navigation, the salient portion may correspond a crosswalk edge (e.g., a right corner) and/or a cross street (e.g., a left corner). The salient area may correspond to areas paid most attention by a trainer (e.g., an experienced driver and/or an instructor) as observed during training of the computerized navigation assist system.

At operation 928 a determination may be made as to whether user gaze determined at operation 922 matches the target attention determined at operation 926. A variety of methodologies may be used for detecting the match. In some implementations, the match may be determined based on an evaluation of coordinates of the user gaze (user attention) area and coordinates of the target attention area. In one or more implementations, the discrepancy may be based on a distance measure, a norm, a maximum absolute deviation, a signed/unsigned difference, a correlation, a point-wise comparison, and/or a function of an n-dimensional distance (e.g., a mean squared error). In one or more implementations, the match may be determined based on a frequency and/or duration of the user gaze corresponding to the target attention area.

Responsive to detecting a mismatch between the user attention and the target attention, the method may proceed to operation 930 wherein an indication may be provided. In one or more implementations, the indication may comprise an audible alarm, an indication visible on a vehicle windshield (e.g., a flashing marker pointing towards right corner, a flashing rectangle over the crosswalk, and/or other indications). Various other attention indications may be utilized in order to assist the driver, e.g., using an in vehicle display, a warning light, and/or other attention means.

FIG. 9C is logical flow diagram illustrating a method of processing sensory information by a computerized device using saliency maps, in accordance with one or more implementations. Operations of method 960 may be performed, for example, by a computerized device configured to automatically process camera feeds (e.g., 310 in FIG. 3) in one or more implementations of premises security.

At operation 962 context associated with the task may be determined. In some implementations premises security and/or surveillance implementations, the context may comprise sensory information provided by, e.g., a plurality of cameras, proximity sensors, contact sensors, pressure, infrared, electromagnetic, and/or other sensors, a list of potential targets, and/or objects, premises layout, hours of operation, time of day/week, and or other parameters. In some implementations, the context may comprise one or more aspects of sensory input, e.g., motion in one or more frames 320, feature persistence, unexpected changes from frame to frame, and/or other characteristics of sensory input that may be relevant to the task. By way of an illustration of a surveillance implementation, the context may comprise one or more of a camera feed stream 310 of FIG. 3, after-hours current time, and a security policy wherein doors should remain locked and no person should be present on premises.

At operation 964, a salient element may be determined for the context determined at operation 962 using an adaptive predictor. In one or more implementations, the adaptive predictor may be configured based on training operations, e.g., such as described above with respect to method 800 of FIG. 8. In some implementations of surveillance, the salient areas may correspond to one or more displays (and/or a portion of) (e.g., 322, 328 in FIG. 3) presenting camera feeds. By way of an illustration, the context areas may correspond to feeds from cameras proximate doors and/or interior of the premises. The saliency map may correspond to areas paid most attention by a trainer (e.g., an experienced security officer) obtained during training of the surveillance system.

At operation 968 one or more features may be determined in sensory input. The feature may comprise an object (e.g., a piece of luggage, a car), a person, a state (e.g., open window/door), a condition (water, smoke), and/or other premises conditions. In one or more premises security implementations, the sensory input may comprise a stream of pixel values associated with one or more digital images. In some implementations (e.g., video, radar, sonography, x-ray, magnetic resonance imaging, and/or other types of sensing), the input may comprise electromagnetic waves (e.g., visible light, IR, UV, and/or other types of electromagnetic waves) entering an imaging sensor array. In some implementations, the imaging sensor array may comprise one or more of RGCs, a charge coupled device (CCD), an active-pixel sensor (APS), and/or other sensors. The input signal may comprise a sequence of images and/or image frames. The sequence of images and/or image frame may be received from a CCD camera via a receiver apparatus and/or downloaded from a file. The image may comprise, for example, a two-dimensional matrix of RGB values refreshed at a 25 Hz frame rate. It will be appreciated by those skilled in the arts that the above image parameters are merely exemplary, and many other image representations (e.g., bitmap, CMYK, HSV, HSL, grayscale, and/or other representations) and/or frame rates are equally useful with the present technology. Pixels and/or groups of pixels associated with objects and/or features in the input frames may be encoded using, for example, latency encoding described in commonly owned and co-pending U.S. patent application Ser. No. 12/869,583, filed Aug. 26, 2010 and entitled “INVARIANT PULSE LATENCY CODING SYSTEMS AND METHODS”; U.S. Pat. No. 8,315,305, issued Nov. 20, 2012, entitled “SYSTEMS AND METHODS FOR INVARIANT PULSE LATENCY CODING”; Ser. No. 13/152,084, filed Jun. 2, 2011, entitled “APPARATUS AND METHODS FOR PULSE-CODE INVARIANT OBJECT RECOGNITION”; and/or latency encoding comprising a temporal winner take all mechanism described U.S. patent application Ser. No. 13/757,607, filed Feb. 1, 2013 and entitled “TEMPORAL WINNER TAKES ALL SPIKING NEURON NETWORK SENSORY PROCESSING APPARATUS AND METHODS”, each of the foregoing being incorporated herein by reference in its entirety.

The context may combine information from one or more sensors of one or more sensing modalities, disposed at a single or multiple locations, and operating at one or more spatial/temporal time scales. The context may include representations of non-sensory inputs, for example: level of alert, status of particular objects (e.g. “expected to be removed” or “should not be moved”), and/or other non-sensory data.

In one or more implementations, encoding may comprise adaptive adjustment of neuron parameters, such neuron excitability described in commonly owned and co-pending U.S. patent application Ser. No. 13/623,820 entitled “APPARATUS AND METHODS FOR ENCODING OF SENSORY DATA USING ARTIFICIAL SPIKING NEURONS”, filed Sep. 20, 2012, the foregoing being incorporated herein by reference in its entirety. In some implementations, the feature detection operation 968 may be performed for the silent area identified at operation 964.

At operation 970 a determination may be made as to whether a feature may be present in the salient area identified at operation 964. A variety of methodologies may be used for detecting the feature. In some implementations, the object presence may be determined based on an evaluation of coordinates associated with the feature and extent of the salient area. In some implementations, information (e.g. human- and/or machine-understandable labels of specific categories of features or objects) may be learned and/or programmed simultaneously or subsequently to the salience training. In some implementation, a separate classifier module may be trained or programmed to classify the features and objects learned in salience training. In some implementations, objects or features associated with the area of high salience are tested against one or more commercial or custom-built database (e.g. to find and report best matches). In some implementations, objects or features associated with the area of high salience may be recorded (e.g. as still images, video, audio, etc.) and transmitted to be viewed by a human operator or operators. In some implementations, when in a certain area the salience determined by operation 964 may be sufficiently high (e.g., breaches a target threshold), an alarm or indication is issued even in the case when operation 970 failed to identify the specific object or feature that produced the high salience in operation 964.

Responsive to a determination that a feature may be present in the salient area, the method may proceed to operation 972 wherein an indication may be provided. In one or more implementations, the indication may comprise an audible alarm, an indication visible on a vehicle windshield (e.g., a flashing marker pointing towards right corner, a flashing rectangle over the crosswalk, and/or other indication means). Various other attention indications may be utilized in order to assist the driver, e.g., using an in vehicle display, a warning light, and/or other assistance means.

Using gaze information for training of robotic controllers to determine one or more salient aspects of sensory input may provide a straight-forward interface that may enable the trainer and/or the robot to respond timely to rapid changes in sensory input e.g., during vehicle navigation, and/or to process large quantities of data autonomously. The gaze based methodology of the present disclosure may provide a mechanism for transferring knowledge from an experienced user (e.g., trainer) to novice users via a robotic assist mechanism described above. Methodology for training of robots utilizing gaze-based saliency maps may be employed in a variety of applications, including, e.g., autonomous navigation, robot assisted navigation, robot-assisted living, data mining, surveillance, surveying, and/or other applications of robotics.

It will be recognized that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed implementations, or the order of performance of two or more steps permuted. All such variations are considered to be encompassed within the disclosure disclosed and claimed herein.

While the above detailed description has shown, described, and pointed out novel features of the disclosure as applied to various implementations, it will be understood that various omissions, substitutions, and changes in the form and details of the device or process illustrated may be made by those skilled in the art without departing from the disclosure. The foregoing description is of the best mode presently contemplated of carrying out the principles of the disclosure. This description is in no way meant to be limiting, but rather should be taken as illustrative of the general principles of the disclosure. The scope of the disclosure should be determined with reference to the claims.

What is claimed is:

1. A system configured for determining a saliency map, the system comprising:
a first sensing apparatus configured to provide sensory input associated with a task being executed by a robotic device operable by a trainer;
a second sensing apparatus configured to provide information related to a gaze parameter associated with a present gaze of the trainer;
one or more processors communicatively coupled with one or both of the first sensing apparatus or the second sensing apparatus, the one or more processors being configured to execute computer program instructions to cause the one or more processors to:
determine one or more features within the sensory input using an adaptive process;
determine a salient area within the sensory input based on the gaze parameter;
associate the salient area with at least one of the one or more features; and
update a learning parameter of the process based on an evaluation of the association;
wherein:
the learning process is characterized by a performance measure;
the update is configured to effectuate autonomous execution of the task by the robotic device in an absence of the trainer; and
the saliency map comprises the salient area.

2. The system of claim 1, wherein:
the present gaze is configured to convey information related to direction of eye sight of the trainer;
the sensory input comprises a first image and a second image both conveying information related to an environment surrounding the robotic device during execution of the task; and
the gaze parameter is determined based on an operation configured using to a first portion within the first image and a second portion of the second image being gazed at by the trainer.

3. The system of claim 2, wherein the operation comprises a weighted average of the first portion and the second portion.

4. The system of claim 1, wherein:
the sensory input comprises an image characterized by a spatial extent, the image conveying information related to an environment surrounding the robotic device during execution of the task;
the present gaze of the trainer is characterized by a plurality of areas within the spatial extent being observed by the trainer, a given area within the spatial extent being characterized by a duration of the present gaze directed to the given area, a location of the given area within the spatial extent, and a perimeter of the given area; and
the gaze parameter is determined based on a spatial average of the individual areas.

5. The system of claim 4, wherein:
the sensory input comprises another image conveying information related to the environment surrounding the robotic device during execution of the task; and
the gaze parameter is determined based on a temporal average of the individual areas associated with the image and the other image.

6. The system of claim 4, wherein:
the association of the salient area with the at least one of the one or more features comprises determining a first location within the image associated with the salient area and a second location within the image associated with the at least one of the one or more features; and
the evaluation comprises a determination of a similarity measure between the first location and the second location.

7. The system of claim 6, wherein:
the one or more processors are configured to operate a network of a plurality of computerized neurons configured to implement the learning process; and
the network comprises an input layer of neurons and an output layer of neurons.

8. The system of claim 7, wherein:
the similarity measure is configured to provide a discrepancy between the first location and the second location; and
the update is configured based on propagation of the discrepancy from the output layer back to the input layer.

9. The system of claim 1, further comprising:
a nonvolatile storage medium configured to store the updated learning parameter;
wherein the second sensing apparatus comprises:
an optical gaze tracker comprising a transmitter element configured to illuminate an eye of the trainer; and
a receiver element configured to detect a waveform reflected by the eye.

10. A non-transient computer-readable storage medium having instructions embodied thereon, the instructions being executable to cause one or more processors to:
determine of a gaze of a person executing a task;
determine one or more features in sensory input associated with the task;
select a salient feature from the one or more features, the selection being based on an operation of a predictor process characterized by a parameter;
associate an area of the gaze of the person with a portion of the sensory input; and
provide an indication to the person, the indication conveying information associated with the salient feature and the area;
wherein the parameter is based on an evaluation of gaze of another person during a prior execution of the task prior.

11. The apparatus of claim 10, wherein the indication comprises an alert for the person, the alert being responsive to a discrepancy between (i) an area of the sensory input associated with the salient feature and (ii) the area of the gaze, the alarm being configured to attract attention of the person to the discrepancy.

12. The apparatus of claim 11, wherein the alarm comprises one or more of an audible indication, a visible indication, or tactile indication.

13. The apparatus of claim 11, wherein:
the task comprises navigating a trajectory by a vehicle;
the alarm is configured to indicate to the person the area of the sensory input associated with the salient feature; and
the alarm is configured to cause generation of a graphical user interface element on a display component of the vehicle, the display component configured to present to the person at least a portion of the sensory input.

14. The apparatus of claim 13, wherein:
the silent feature comprises an object disposed proximate the trajectory; and
the graphical user interface element conveys one or more of a location of the object or a boundary of the object.

15. The apparatus of claim 10, wherein
the salient feature is determined based on determining a salient area within the sensory input; and
the indication comprises an alert for the person, the alert being responsive to an absence of the gaze within the salient area for a period of time.

16. The apparatus of claim 15, wherein:
the task comprises navigating a trajectory by a vehicle;
the sensory input comprises a sequence of frames obtained at an inter frame duration; and
the interval comprises a period of multiple inter-frame duration.

17. The apparatus of claim 16, wherein:
for an inter frame duration of 40 milliseconds, the interval is selected to be greater than 400 milliseconds.

18. A method for operating a robotic apparatus to perform a task, the method comprising:
for a given visual scene:
determining a feature within a portion of a digital image of the visual scene, the determination being based on an analysis of a saliency map associated with the task, the saliency map being representative of one or more areas of preferential attention by a human trainer; and
executing the task based on an association between with the feature and the task;
wherein:
the saliency map is determined by a learning process of the robotic apparatus;
the association between with the feature and the task is determined by the learning process;
the learning process has been previously trained to execute the task using gaze of the human trainer.

19. The method of claim 18, further comprising:
using the saliency map, as determined from the human gaze, to specify the feature associated with the robotic apparatus so that the robotic apparatus learns the association between the feature and the task.
